(19) United States
(12) Patent Application Publication
(10) Pub. No.: US 2026/0353538 A1
(43) Pub. Date: Nov. 5, 2026

(54) METHOD AND SYSTEM FOR CONTROLLING LIGHT EMISSION BASED ON AUDIO RESPONSE

(71) Applicant: HYBE Co., Ltd., Seoul (KR)

(72) Inventor: Bo Yoon CHOI, Seoul (KR)

(21) Appl. No.: 19/416,346

(22) Filed: Dec. 11, 2025

(30) Foreign Application Priority Data
Apr. 22, 2025 (KR) 10-2025-0052598
Apr. 22, 2025 (KR) 10-2025-0052599

(51) Int. Cl. H05B 47/12; G05D 25/02; G10H 1/00; G10L 15/08; G10L 15/183; G10L 15/30; G10L 21/0208; G10L 25/63; H05B 47/19

(52) U.S. Cl. CPC H05B 47/12; G05D 25/02; G10H 1/0008; G10L 15/183; G10L 15/30; G10L 21/0208; G10L 25/63; H05B 47/19; G10H 2210/071; G10H 2210/076; G10H 2240/075; G10L 2015/088

(57) ABSTRACT

According to an embodiment of the present disclosure, a method for controlling light emission based on an audio response is performed by an application of a central control terminal, and includes: acquiring sound through at least one sound collection microphone; extracting audio data from the acquired sound; acquiring first sound pattern data, which is a section having a predetermined sound pattern, from the audio data; generating light emission information that specifies a light emission form of a light-emitting device by adjusting a light emission speed or a light emission pattern according to metadata matched to the first sound pattern data; and transmitting the generated light emission information to a predetermined light-emitting device.

### CROSS-REFERENCE TO RELATED APPLICATION

This application claims the benefit of and priority to Korean Patent Applications No. 10-2025-0052598, filed on Apr. 22, 2025, and No. 10-2025-0052599, filed on Apr. 22, 2025, the entire disclosure of which is hereby incorporated herein by reference in its entirety.

### BACKGROUND

### Field

The present disclosure relates to a method and system for controlling light emission based on an audio response. More particularly, the present disclosure relates a method and system that via a central control terminal, control the light emission speed of a light-emitting device based on audio sensed at a field (e.g., a sports stadium), and that analyze field sounds using artificial intelligence (AI) to recognize a situation and control a light emission pattern accordingly.

### Description of Related Art

Recently, audience members at organized events such as performances, events, and sporting events have used light-emitting devices in the stands for various reasons, including cheering, aesthetic effects, and the ambiance of the event.

These light-emitting devices were manually controlled by producers or presenters in accordance with the sound source. However, these light-emitting devices are unable to automatically respond to real-time changes in the sound source, making it difficult to create responsive productions.

Furthermore, simply controlling the light emission speed based on the BPM of the sound source may be limited in that they fail to fully reflect the atmosphere or context of a stadium. For example, even for the same shouting sound, the light emission color or pattern is required to vary depending on whether the shouting sound is a cheer for a goal from the team a user cheers for or a booing of the opposing team. However, conventional technology is unable to distinguish between these two shouting sounds, resulting in inappropriate productions.

Furthermore, it is difficult to synchronize individual light-emitting devices in concert halls or sports stadiums, and there is a limitation for producers to adjust all situations in real time.

In particular, lighting effects at sports games are required to vary depending on cheering songs or game events. However, existing methods may not automate the same, and thus there is a limitation in creating productions having a sense of realism.

Accordingly, there is a need for a complex light emission control technology that recognizes in real time not only the physical characteristics of audio (BPM, speed) but also situational information such as emotions, direction, and events included in the audio, thereby reflecting both a sense of rhythm and a field situation.

### RELATED ART DOCUMENTS

### Patent Documents

(Patent Document 1) Korean Patent No. 10-2308999 B1

(Patent Document 2) Korean Patent No. 10-2660527 B1

### SUMMARY

The present disclosure has been devised to obviate the above limitations of the related art. An aspect of the present disclosure is directed to providing a method and system for controlling light emission based on an audio response, which controls the light emission speed and light emission pattern of a light-emitting device based on audio sensed in the field based on a central control terminal.

In addition, an aspect of the present disclosure is directed to providing a method and system for controlling light emission based on an audio response, which controls a light-emitting device and/or a central control device to emit light with light emission information matching BPM information acquired using a BPM tracker.

In addition, an aspect of the present disclosure is directed to providing a method and system for controlling light emission based on an audio response, which analyzes a predetermined sound pattern and ambient sound and controls a light-emitting device to emit light according to light emission information appropriate to a situation.

However, technical aspects to be achieved by the present disclosure and embodiments according to the present disclosure are not limited to the technical aspects described above, and other technical aspects may also exist.

A method for controlling light emission based on an audio response according to an embodiment of the present disclosure pertains to a method for controlling light emission based on an audio response by an application of a central control terminal, and includes: acquiring sound through at least one sound collection microphone; extracting audio data from the acquired sound; acquiring first sound pattern data, which is a section having a predetermined sound pattern, from the audio data; generating light emission information that specifies a light emission form of a light-emitting device by adjusting a light emission speed or a light emission pattern according to metadata matched to the first sound pattern data; and transmitting the generated light emission information to a predetermined light-emitting device.

In addition, the generation of the light emission information includes at least one of: determining light emission pattern information by setting each of the values of a plurality of light emission pattern components; or determining pre-stored production data by determining the values of the plurality of light emission pattern components in advance.

In addition, the transmission of the generated light emission information to the predetermined light-emitting device includes including, in a control signal to be transmitted, a control command for causing the light-emitting device to emit light based on at least one of the light emission pattern information or the production data, with light emission speed information included in the light emission information.

In addition, the extraction of the audio data includes: amplifying the acquired sound based on a light emission control system; removing noise from the amplified sound based on a noise removal algorithm; extracting features or keywords from the noise-removed sound based on a deep learning model pre-trained with an audio dataset; and extracting first sound pattern data corresponding to the features or keywords of the extracted sound from audio data pre-stored in a database.

In addition, the acquisition of the first sound pattern data includes at least one of: reading BPM information from the first sound pattern data in a metadata format in which at least one of the BPM information, which is feature information that determines a speed of the first sound pattern data, light emission pattern information that determines a light emission attribute of the light-emitting device, or light emission speed information that determines a light emission speed of the light-emitting device, is tagged in advance; or measuring the BPM information of the first sound pattern data included in the audio data based on the light emission control system.

In addition, the measurement of the BPM information of the first sound pattern data based on the light emission control system includes: determining, when a change in a first BPM value to a second BPM value is sensed, a section in which the first BPM value is maintained as the first sound pattern data; and determining the first BPM value as the BPM information in the determined first sound pattern data.

In addition, the generation of the light emission information includes generating the light emission information by determining at least one of: section information determining which section of the extracted audio data the first sound pattern data corresponds to; the light emission pattern information determining at least one light emission pattern component value among a light emission mode, light emission color, light emission time, light emission brightness, and light emission effect; or the light emission speed information determining the light emission speed based on BPM information of the section information.

In addition, the generation of the light emission information by determining the light emission pattern information includes one of: determining the light emission pattern component value based on a mapping table that corresponds the light emission pattern information and production data by BPM range; or automatically acquiring and determining recommended light emission pattern information on the BPM information using a light emission pattern generation algorithm.

In addition, the determination of the light emission pattern component value based on the mapping table further includes determining a serial number of the production data in which a plurality of light emission pattern component values are determined in advance and a first light emission pattern component change value to be changed in the production data.

The method further includes: sensing a specific rhythm section from first sound pattern data included in the audio data; and generating section production information that sets light emission pattern information matching the first sound pattern data to be played at a light emission timing corresponding to a timestamp recorded in the sensed specific rhythm section.

Furthermore, the method further includes transferring, to the light-emitting device, a control command to give priority to the generated section production information over metadata of the first sound pattern data when the section production information is generated.

In addition, the transmission of the generated light emission information to the predetermined light-emitting device includes generating a control command that activates first production data included in the generated light emission information among production data pre-stored in a plurality of the light-emitting devices.

In addition, the extraction of the audio data further includes: classifying the audio data into sound pattern data and verbal data; and matching a situation tag including at least one situation parameter to the extracted audio data using a situation recognition algorithm.

In addition, the matching of the situation tag includes: determining the at least one situation parameter based on at least one artificial intelligence model among an emotion analysis model that analyzes ambient sounds of the audio data to determine emotion parameters, a direction analysis model that analyzes a direction of occurrence of the audio data to determine team parameters, and a game analysis model that performs voice recognition and natural language processing to determine event parameters; and matching a situation tag including the determined at least one situation parameter to the audio data.

In addition, the determination of the light emission pattern information further includes: additionally detecting second audio data from sounds including the audio data; recognizing a new situation tag from the second audio data; and generating second light emission pattern information by changing at least one light emission pattern component among the light emission pattern information corresponding to the audio data according to the recognized new situation tag.

A system for controlling light emission based on an audio response according to an embodiment of the present disclosure is interlocked with at least one light-emitting device, and includes: at least one memory; and at least one processor assembly, wherein at least one application stored in the memory and executed by the processor assembly to perform a method for controlling the light emission based on the audio response operates in accordance with instructions for: acquiring sound through at least one sound collection microphone; extracting audio data from the acquired sound; acquiring first sound pattern data, which is a section having a predetermined sound pattern, from the audio data; generating light emission information that specifies a light emission form of the light-emitting device by adjusting a light emission speed or a light emission pattern according to metadata matched to the first sound pattern data; and transmitting the generated light emission information to a predetermined light-emitting device.

In addition, the light-emitting device according to an embodiment of the present disclosure includes: a short-range transceiver that receives a control signal including a control command to emit light with predetermined emission information; a light-emitting unit that performs light emission with the received light emission information; and a processor that controls the light emission, wherein the processor of the light-emitting device performs an operation to: acquire sound through at least one sound collection microphone; extract audio data from the acquired sound; acquire first sound pattern data, which is a section having a predetermined sound pattern, from the audio data; determine at least one of light emission pattern information or production data that matches the acquired first sound pattern data; and adjust at least one of a light emission speed or a light emission pattern for at least one of the determined light emission pattern information or production data.

The method and system for controlling the light emission based on the audio response according to an embodiment of the present disclosure, automatically determine light emission effects based on game situations by controlling the light emission speed and light emission pattern of light-emitting devices based on audio sensed at a field through the central control terminal, thereby significantly enhancing the senses of realism and immersion.

Furthermore, the method and system for controlling the light emission based on the audio response according to an embodiment of the present disclosure allow audience members to link to a cheering system simply by carrying light-emitting devices, without the need for prior production memory work and/or field producers or presenters, thereby eliminating the inconvenience of manual control by users and producers, and allowing numerous audience members to simultaneously implement the same production to provide a unique cheering experience for the audience members.

Furthermore, the method and system for controlling the light emission based on the audio response according to an embodiment of the present disclosure analyzes a predetermined sound pattern and ambient sound and controls the light-emitting device to emit light according to the light emission information appropriate to a situation, thereby maximizing the storytelling of a game and the excitement of cheering by reflecting the light emission pattern according to the game section, ambient sounds, and field situations.

The benefits of the present disclosure are not limited to those mentioned above, and other benefits not mentioned may be clearly understood by those skilled in the art from the following description.

### BRIEF DESCRIPTION OF THE DRAWING

FIG. 1 is a conceptual diagram illustrating a system for controlling light emission according to an embodiment of the present disclosure.

FIG. 2 is an internal block diagram illustrating a central control terminal according to an embodiment of the present disclosure.

FIG. 3 is an internal block diagram illustrating a light-emitting device according to an embodiment of the present disclosure.

FIG. 4 is a flowchart illustrating a method for controlling a light emission speed of a light-emitting device according to an embodiment of the present disclosure.

FIG. 5 is a diagram illustrating BPM information work for audio data according to an embodiment of the present disclosure.

FIG. 6 is a diagram illustrating light emission information according to an embodiment of the present disclosure.

FIG. 7 is an example of a first mapping table corresponding to BPM range-specific light emission pattern information according to an embodiment of the present disclosure.

FIG. 8 is an example of a diagram illustrating section production information according to an embodiment of the present disclosure.

FIG. 9 is a flowchart illustrating a method for controlling a light emission pattern according to situation recognition according to an embodiment of the present disclosure.

FIG. 10 is an example of a second mapping table corresponding to a situation tag and a light emission pattern component according to an embodiment of the present disclosure.

FIG. 11 is a schematic diagram illustrating an example of a method for generating second light emission pattern information according to an embodiment of the present disclosure.

### DETAILED DESCRIPTION

Embodiments of the present disclosure will be shown in the drawings and described in detail through a detailed description. However, the present disclosure may be variously modified and embodied in a variety of different embodiments. Advantages and features of the present disclosure and implementation methods thereof will be clarified through the following embodiments described with reference to the accompanying drawings. Therefore, the present disclosure is not limited to these embodiments introduced hereinafter and might be embodied in a different shape from these embodiments. The terms “first,” “second,” and so on in the present disclosure are used for distinguishing one component from the other components, but they do not specify limited meanings. Also, the singular forms used in the present disclosure are intended to include the plural forms, unless the context clearly indicates otherwise. Moreover, the terms “comprises” and/or “having” described in the present disclosure specify the presence of stated components and/or features, but do not preclude the presence or addition of one or more other components and/or features. Furthermore, the size or the thickness of each component in the drawings can be exaggerated or reduced for the definiteness of explanation. For example, the size and the thickness of each component in the drawings are arbitrarily represented for the convenience of explanation. In accordance therewith, the present disclosure is not limited to the matters shown in the drawings.

Reference will now be made in detail to the embodiments of the present disclosure with reference to the accompanying drawings. Wherever possible, the same reference numbers will be used throughout the disclosure including the drawings to refer to the same or like parts. As such, the repeatable description of the same or like parts will be omitted.

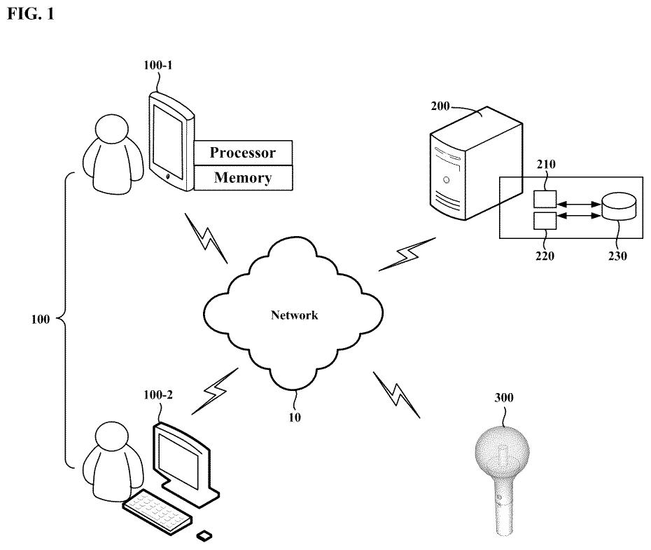

FIG. 1 is a conceptual diagram illustrating a system for controlling light emission according to an embodiment of the present disclosure.

Referring to FIG. 1 the system for controlling the light emission according to an embodiment of the present disclosure may provide a light emission speed control service (hereinafter, a “light emission speed control service”) that controls the light emission speed of a light-emitting device based on audio sensed at a field through a central control terminal, and an AI-based light emission control service (hereinafter, a “light emission pattern control service”) that analyzes sounds output at a field based on AI to recognize situations and controls light-emitting devices at a field to emit light in a light emission pattern appropriate for the recognized situation.

Hereinafter, the light emission speed control service and the light emission pattern control service are collectively referred to as a “light emission control service.”

Prior to the description, for a more effective explanation, some terms used in the method for controlling the light emission speed of the light-emitting device will be first defined.

In an embodiment, the audio data may be at least one of a sound source related to a sports game, a cheering song, a sound effect, an alarm sound and/or the voice of a person leading the sports game, or words and/or sentences included therein.

The audio data may be classified into sound pattern data and/or verbal data.

The sound pattern data may refer to data having a predetermined sound pattern in music and soundtracks of predetermined music files, such as background music, cheering songs, theme songs, and cheering songs for each player, directly or indirectly related to a sports game among audio data.

The verbal data may refer to the voices of persons related to a sports game (for example, hosts, commentators, stadium announcers, or announcements) and words or sentences included therein.

In addition, in an embodiment, BPM information may refer to feature information, such as the tempo and/or beat of a sound source.

Herein, the light emission information according to an embodiment may refer to information on a light emission pattern, including the light emission color and/or light emission effect required for the operation of the light-emitting device that operates in response to a control signal.

In detail, the light emission information according to an embodiment may include all pieces of information related to light emission, such as production data, which is a collection of data pre-stored in the light emission pattern, the serial number of the production data, color, effect, light emission time, signal cycle, speed, and/or light emission state.

In addition, the light emission information according to an embodiment may further adjust the speed of the light emission pattern information according to the BPM information.

Herein, the production data according to an embodiment may refer to a set of data that pre specifies the resources of light emission information including light emission patterns according to the BPM information. For example, the production data may be pre-stored in the system as a library, and predetermined performance scenes or group information may be tagged and stored.

In detail, the production data according to an embodiment may include light emission information pre-matched to the BPM information, words, comments, and/or sound patterns.

In addition, the light emission pattern information may refer to a light emission form in which a light-emitting device 300 operates according to components including a light emission mode (for example, ON mode, OFF mode, and/or sound recognition mode), light emission color, light emission time, light emission brightness, and/or light emission effect.

Herein, the light emission effect may refer to a light emission form in which the components are set to change within a predetermined time to create a dynamic visual effect.

For example, the light emission effect may include 1) a blinking effect that quickly flashes a light-emitting unit 330 by setting the light emission differently for each time zone within a predetermined period of time, 2) a gradation effect in which the light emission color is set differently for each time zone within a predetermined period of time and gradually changes, and 3) a fade in/out effect in which the brightness gradually decreases or brightens for each time zone.

In addition, the site where the light emission pattern control service is provided includes various places such as event halls, artist performance halls, and/or sports stadiums. However, in the following embodiments, for the convenience of explanation, the description is limited to the service provided at a sports stadium.

In an embodiment, the light emission speed control service system implementing the light emission speed control service as described above may be connected through a central control terminal 100, a service providing server 200, the light-emitting device 300, and a network 10.

Herein, the network 10 according to an embodiment refers to a connection structure capable of exchanging information between nodes such as the central control terminal 100 and/or the light-emitting device 300. Examples of the network 10 include 3GPP (3rd Generation Partnership Project) network, LTE (Long Term Evolution) network, WIMAX (World Interoperability for Microwave Access) network, Internet, LAN (Local Area Network), Wireless LAN (Wireless Local Area Network), WAN (Wide Area Network), PAN (Personal Area Network), Bluetooth network, Satellite Broadcasting Network, Analog Broadcasting Network, and DMB (Digital Multimedia Broadcasting) network, but are not limited thereto.

Hereinafter, the central control terminal 100 and the light-emitting device 300 implementing the light emission speed control system will be described in detail with reference to the attached drawings.

### Central Control Terminal 100

The central control terminal 100 according to an embodiment of the present disclosure may be a predetermined computing device having a light emission control application (hereinafter, an “application”) installed that provides the light emission control service.

Specifically, from a hardware point of view, the central control terminal 100 may include a mobile-type computing device 100-1 and/or a desktop-type computing device 100-2 in which the application is installed.

Herein, the mobile-type computing device 100-1 may be a mobile device such as a smartphone or tablet PC in which the application is installed.

For example, the mobile-type computing device 100-1 may include a smartphone, a mobile phone, a digital broadcasting terminal 100, a personal digital assistant (PDA), a portable multimedia player (PMP), and a tablet PC.

In addition, the desktop-type computing device 100-2 may include a device installed with a program to execute the light emission control service based on wired/wireless communication such as a fixed-type desktop PC, a laptop computer, and a personal computer such as an Ultrabook in which the application is installed.

In addition, according to an embodiment, the central control terminal 100 may further include a predetermined server computing device that provides a light emission control service environment.

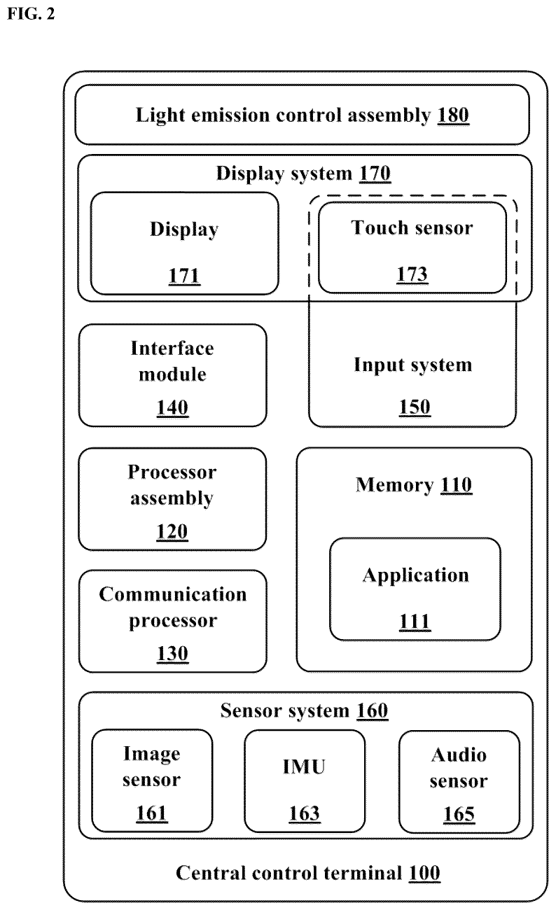

FIG. 2 is an internal block diagram illustrating a central control terminal according to an embodiment of the present disclosure.

Referring to FIG. 2, from a functional point of view, the central control terminal 100 may include a memory 110, a processor assembly 120, a communication processor 130, an interface module 140, an input system 150, a sensor system 160, a display system 170, and a light emission control assembly 180. These components may be configured to be included within a housing of the central control terminal 100.

Specifically, the memory 110 may store an application 111, and the application 111 may store one or more of various application programs, data, and instructions for providing the light emission control service environment.

In other words, the memory 110 may store commands and data used for generating the light emission control service environment.

In addition, the memory 110 may include a program area and a data area.

Herein, the program area according to an embodiment may be linked between an operating system (OS) for booting the central control terminal 100 and functional elements, and the data area may store data generated according to the use of the central control terminal 100.

In addition, the memory 110 may include at least one non-transitory computer-readable storage medium and a temporary computer-readable storage medium.

For example, the memory 110 may be various storage devices, such as a ROM, an EPROM, a flash drive, and a hard drive; and may be a web storage performing a storage function of the memory 110 on the Internet.

The processor assembly 120 may include at least one processor capable of executing commands of the application 111 stored in the memory 110 to perform various tasks for generating the light emission control service environment.

In an embodiment, the processor assembly 120 may control the overall operation of components through the application 111 of the memory 110 in order to provide the light emission control service.

The processor assembly 120 may be a system-on-chip (SOC) suitable for the central control terminal 100 that includes a central processing unit (CPU) and/or graphics processing unit (GPU), may execute the OS and/or an application program stored in the memory 110, and control each component mounted on the central control terminal 100.

In addition, the processor assembly 120 may communicate with each component internally through a system bus and may include one or more predetermined bus structures including a local bus.

In addition, the processor assembly 120 may be implemented by using at least one of application-specific integrated circuits (ASICs), digital signal processors (DSPs), digital signal processing devices (DSPDs), programmable logic devices (PLDs), field programmable gate arrays (FPGAs), controllers, micro-controllers, microprocessors, or electric units for performing other functions.

The communication processor 130 may include one or more devices for communicating with an external device. The communication processor 130 may communicate through a wireless or wired network.

In detail, the communication processor 130 may communicate with the central control terminal 100 storing a content source for implementing the light emission control service environment, and may communicate with various user input components such as a controller receiving a user input.

In an embodiment, the communication processor 130 may transmit/receive various pieces of data related to the light emission control service to/from another central control terminal 100 and/or an external server.

This communication processor 130 may wirelessly transmit and receive data with at least one of a base station, an external terminal, or an arbitrary server on a mobile communication network built through a communication device capable of performing technical standards or communication methods (for example, LTE (Long Term Evolution), LTE-A (Long Term Evolution-Advanced), 5G NR (New Radio), and WIFI) or short-range communication methods for mobile communication.

The interface module 140 may communicatively connect the central control terminal 100 with one or more other devices. Specifically, the interface module 140 may include wired and/or wireless communication devices that are compatible with one or more different communication protocols.

The central control terminal 100 may be connected to various input/output devices through the interface module 140.

For example, the interface module 140 may be connected to an audio output device such as a headset port or a speaker to output audio.

Although it has been described as an example that the audio output device is connected through the interface module 140, an embodiment in which the audio output device is installed in the central control terminal 100 may also be included.

In addition, for example, the interface module 140 may be connected to an input device such as a keyboard and/or mouse to acquire a user input.

This interface module 140 may include at least one of a wired/wireless headset port, an external charger port, a wired/wireless data port, a memory card port, a port for connecting a device equipped with an identification module, an audio input/output (I/O) port, a video I/O port, an earphone port, a power amplifier, an RF circuit, a transceiver or other communication circuits.

The input system 150 may sense a user input (for example, gestures, voice commands, operation of a button, or other types of input) related to the light emission control service.

Specifically, the input system 150 may include a predetermined button, a touch sensor, and/or an image sensor 161 that receives a user motion input.

In addition, the input system 150 may be connected to an external controller through the interface module 140 to receive a user input.

The sensor system 160 may include various sensors such as an image sensor 161, a position sensor (IMU) 163, an audio sensor 165, a distance sensor, a proximity sensor, and a contact sensor.

Herein, the image sensor 161 may capture an image and/or a video of a physical space around the central control terminal 100.

In an embodiment, the image sensor 161 may capture and acquire various images and/or videos related to the light emission control service.

In addition, the image sensor 161 may be disposed on the front or/and rear side of the central control terminal 100 to acquire an image by capturing the disposed direction side, and may capture a physical space through a camera disposed toward the outside of the central control terminal 100.

In addition, the image sensor 161 as described above may be included in the central control terminal 100 and operated according to an embodiment, or may be included in an external device (for example, an external server) and operated through linkage based on the communication processor 130 and/or the interface module 140 described above.

The IMU 163 may sense at least one of the motion and acceleration of the central control terminal 100. For example, the IMU 163 may include a combination of various position sensors such as an accelerometer, a gyroscope, and a magnetometer.

In addition, the IMU may interwork with the position communication processor 130, such as GPS of the communication processor 130, to recognize spatial information on the physical space around the central control terminal 100.

The audio sensor 165 may recognize a sound around the central control terminal 100.

In detail, the audio sensor 165 may include a sound source collection microphone capable of sensing audio input output from a site.

In an embodiment, the audio sensor 165 may receive speech data necessary for the light emission control service from a user.

The display system 170 may output various pieces of information related to the light emission control service as a graphic image.

In an embodiment, the display system 170 may display various user interfaces for the light emission control service.

Such a display may include at least one of a liquid crystal display (LCD), a thin-film transistor-liquid crystal display (TFT LCD), an organic light-emitting diode (OLED), a flexible display, a 3D display, or an electronic ink display (e-ink display).

The above components may be disposed within the housing of the central control terminal 100, and a user interface may include a touch sensor 173 on a display 171 configured to receive a user touch input.

In detail, the display system 170 may include the display 171 that outputs an image and the touch sensor 273 that senses a user touch input.

For example, the display 171 may form an overlaid structure with the touch sensor 173 or be integrally formed to be implemented as a touch screen. Such a touch screen may function as a user input unit that provides an input interface between the central control terminal 100 and the user, and may provide an output interface between the central control terminal 100 and the user.

The light emission control assembly 180 may include a BPM tracker, a sound amplifier, a repeater, and/or an antenna.

The BPM tracker may refer to a module that measures the tempo of a repetitive sound, including a sound source, based on beats per minute (BPM).

The sound amplifier may refer to a device that amplifies a predetermined electrical signal included in an audio signal output from a site at a fixed rate.

The repeater may refer to a device that transmits and receives an audio signal by regenerating the attenuated signal when the audio signal is acquired or output from a site and the signal is attenuated due to long-distance transmission.

The antenna may refer to a device that transmits and/or receives radio waves in a specific range.

In this connection, the central control terminal 100 and the antenna may have a 1:1 and/or 1:n relationship. In this connection, the antenna may be a directional antenna.

The antenna may be installed at least once inside or outside a performance hall and/or sports stadium. In other words, the central control terminal 100, according to an embodiment, may serve as a repeater that transmits and receives signals to and from a plurality of light-emitting devices 300 based on the light emission control assembly 180.

In an embodiment, the central control terminal 100 may recognize the BPM of a predetermined audio for controlling the light emission speed of the light-emitting device based on the light emission control assembly 180.

In addition, in an embodiment, the central control terminal 100 may perform various deep learning for the light emission control service in conjunction with a deep-learning neural network.

Herein, the deep learning neural network according to the embodiment may include a convolution neural network (CNN), Regions with CNN features (R-CNN), Fast R-CNN, Faster R-CNN, and/or Mask R-CNN, and may include any deep learning neural network including an algorithm capable of performing an embodiment which will be described later. In an embodiment of the present disclosure, such a deep learning neural network is not limited or restricted.

In this connection, according to an embodiment, the deep learning neural network may be installed directly in the central control terminal 100 or may operate as a separate device from the central control terminal 100 to perform deep learning for the light emission control service.

According to an embodiment, the central control terminal 100 including the aforementioned components may store, in the memory 110, at least one piece of light emission information, section information, light emission pattern information, light emission speed information, section production information, timestamp information, at least one sound, sound pattern data, verbal data, audio data, situation parameters, situation tags, light emission pattern components and/or light emission pattern information.

According to an embodiment, the central control terminal 100 may further perform at least a portion of the functional operations performed by the service providing server 200, which will be described later.

### Service Providing Server 200

The service providing server 200, according to an embodiment of the present disclosure, may perform a series of processes for providing the light emission pattern control service.

In detail, in an embodiment, the service providing server 200 may provide the light emission pattern control service by exchanging data necessary to enable for a light emission pattern control service process to drive in an external device such as the central control terminal 100 with the external device.

In more detail, in an embodiment, the service providing server 200 may provide an environment in which the application 111 may operate in an external device (in an embodiment, the mobile-type computing device 100-1 and/or the desktop-type computing device 100-2).

To this end, the service providing server 200 may include application programs, data and/or instructions for the application 111 to operate, and may transmit and receive various pieces of data based thereon with the external device.

In addition, in an embodiment, the service providing server 200 may perform various deep learning for the light emission pattern control service in conjunction with a deep-learning neural network.

Herein, the deep learning neural network according to the embodiment may include a convolution neural network (CNN), Regions with CNN features (R-CNN), Fast R-CNN, Faster R-CNN, and/or Mask R-CNN, and may include any deep learning neural network including an algorithm capable of performing an embodiment which will be described later. In an embodiment of the present disclosure, such a deep learning neural network is not limited or restricted.

In this connection, according to an embodiment, the deep learning neural network may be installed directly in the service providing server 200 or may operate as a separate device from the service providing server 200 to perform deep learning for the light emission pattern control service.

In addition, in an embodiment, the service providing server 200 may store at least one machine learning model.

For example, the service providing server 200 may be various machine learning models such as a plurality of neural networks (for example, deep neural networks) that perform the method for controlling the light emission based on situation recognition based on structured/quantitative data or other types of machine learning models, including non-linear models and/or linear models, and may be configured of a combination thereof.

For example, the machine learning model may store linear regression, decision tree, random forest, gradient boosting, pre-trained language model and/or deep learning model. In addition, the neural network may include at least one of feed-forward neural networks, recurrent neural networks (for example, long short-term memory recurrent neural networks), convolutional neural networks, and/or other forms of neural networks.

In an embodiment, to train this machine learning, the service providing server 200 may further include a model trainer.

For example, this model trainer may update one or more parameters of the machine learning model for the light emission pattern control service based on a defined loss function by a backpropagation scheme.

In some implementation examples, the performance of the backpropagation of the error may include performing truncated backpropagation through time. The model trainer may perform multiple generalization techniques (for example, weight reduction, drop-out, and/or knowledge distillation) in order to enhance the generalization capability of the trained machine learning models.

In particular, the model trainer may train the machine learning models based on a series of training data. Herein, the training data may include, for example, different formats of data such as an image, an audio, and/or text.

In addition, according to an embodiment, the service providing server 200 may store a model to be used in each process and a prompt template that serves as a basis for input to the model in order to perform at least a portion of the process performed for the method for controlling the light emission pattern based on the situation recognition through a large-scale language model (LLM).

In an embodiment, the central control terminal 100 may receive at least one machine learning model from the service providing server 200 via the network, store the same in the memory 110, and then execute the stored machine learning model by the processor assembly 120 to perform the light emission pattern control based on the situation recognition.

In another embodiment, the central control terminal 100 may perform operations through the at least one machine learning model in conjunction with the service providing server 200, and may provide the light emission pattern control service to a user (in an embodiment, a user using the central control terminal 100) in a manner of communicating data related thereto with the outside.

For example, the central control terminal 100 may perform the light emission pattern control service in a manner such that the service providing server 200 provides output for the input of a user using the machine learning model via the web.

In addition, the artificial intelligence model may be implemented in such a way that at least some of the machine learning models are executed on the central control terminal 100 and the rest are executed on the service providing server 200.

The following embodiments will be described based on an embodiment in which a deep learning neural network and/or machine learning model are directly installed and performed on the service providing server 200.

In addition, in an embodiment, the service providing server 200 reads a predetermined deep learning neural network drive program built to perform the deep learning from the memory and performs the deep learning described below based on the read-out predetermined deep learning neural network system.

Specifically, in an embodiment, the service providing server 200 may further include a data store computing system (hereinafter, “data store”), which is a storage for continuously storing and managing raw data that serves as the basis of the light emission pattern control service.

The data store may include various forms of data storage, ranging from a file system to cloud storage. For example, the data store may include: a relational database that uses a structured query language (SQL) to define and manipulate data; a NoSQL database that is designed for flexibility and scalability and processes unstructured and semi-structured data; and a database of at least one of data warehouse that centralizes large amounts of data from a plurality of sources and is optimized for querying and analysis, a data warehouse that stores large amounts of raw data in their basic formats of structured, semi-structured, and unstructured data, or a local storage device or network-attached storage (NAS) that store data in files, typically in a format that may be accessed by the computer operating system, as a system used for reporting and data analysis.

In addition, in an embodiment, the service providing server 200 may store and manage various application programs, instructions and/or data for implementing the light emission pattern control service.

In an embodiment, the service providing server 200 may store and manage sound, sound pattern data, verbal data, audio data, situation parameters, situation tags, light emission pattern components, light emission pattern information, artificial intelligence models (in an embodiment, an emotion analysis model, a direction analysis model, a game analysis model, and a language model) and/or a user interface.

However, in an embodiment of the present disclosure, the functional operations that the service providing server 200 may perform are not limited to those described above, and other functional operations may be performed.

Referring further to FIG. 1, in an embodiment, the service providing server 200 as described above may be implemented as a predetermined computing device including at least one processor module 210 for data processing, at least one communication module 220 for data exchange with an external device, and at least one memory module 230 for storing various application programs, data, and/or instructions for providing the light emission pattern control service.

Herein, the memory module 230 may store one or more of an operating system (OS), various application programs, data, or instructions for providing the light emission pattern control service.

In addition, the memory module 230 may include the program area and the data area.

Herein, the program area according to an embodiment may be linked between the OS for booting a server and functional elements, and the data area may store data generated according to the use of the server.

In an embodiment, the memory module 230 may be various storage devices, such as a ROM, a RAM, an EPROM, a flash drive, and a hard drive, and may be a web storage performing a storage function of the memory module 230 on the Internet.

In addition, the memory module 230 may be a detachable recording medium on a server.

The processor module 210 may control the overall operation of each unit to implement the light emission pattern control service.

The processor module 210 may be the SOC suitable for the server that includes the CPU and/or GPU, may execute the OS and/or an application program stored in the memory module 230, and control each component mounted on the server.

In addition, the processor module 210 may communicate with each component internally through a system bus and may include one or more predetermined bus structures including a local bus.

In addition, the processor module 210 may be implemented by using at least one of the ASICs, DSPs, DSPDs, PLDs, FPGAs, controllers, micro-controllers, microprocessors, or electric units for performing other functions.

In the above description, it has been described that the service providing server 200 according to an embodiment of the present disclosure performs the functional operation as described above. However, according to an embodiment, various embodiments may be possible, such as performing at least a portion of the functional operation performed by the service providing server 200 (for example, the central control terminal 100), and further performing at least a portion of the functional operation performed in the external device in the service providing server 200.

### Light-Emitting Device 300

In an embodiment of the present disclosure, the light-emitting device 300 may be a predetermined device that emits light according to a control signal including setting values such as brightness, color, saturation, and effect received from the central control terminal 100 based on the light emission control service.

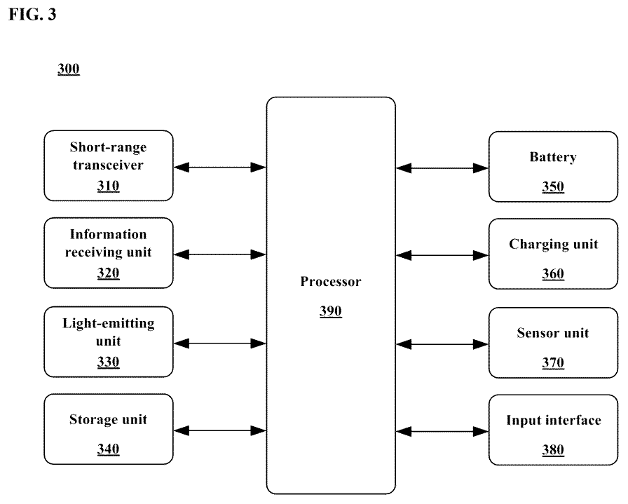

FIG. 3 is an internal block diagram illustrating a light-emitting device according to an embodiment of the present disclosure.

Referring to FIG. 3, in an embodiment, the light-emitting device 300 may include a short-range transceiver 310, an information receiving unit 320, the light-emitting unit 330, a storage unit 340, a battery 350, a charging unit 360, a sensor unit 370, an input interface, and a processor 390.

The short-range transceiver 310 may include one or more devices for communicating with an external device. The short-range transceiver 310 may communicate through a wired or/and wireless network.

In an embodiment, the short-range transceiver 310 may transmit and receive various pieces of data related to the light emission control service to and from another terminal and/or an external server. Specifically, in an embodiment, the short-range transceiver 310 may receive a control signal including a predetermined control command.

The short-range transceiver 310 may include a wireless communication module (for example, at least one of an infrared communication module, an NFC module, an IR transmitter/receiver, an RF transmitter/receiver, a ZigBee module, a Bluetooth module, and a Wi-Fi module).

The information receiving unit 320 may include a broadcast receiver that receives information transmitted by a broadcasting method from a transmitter and other devices. Specifically, the broadcast receiver may receive a radio wave transmitted from the transmitter through an antenna and acquire a control signal by filtering out the control signal from the received radio waves.

In other words, the information receiving unit 320 may receive predetermined information (in an embodiment, light emission pattern information) included in a control signal emitted from the central control terminal 100.

The light-emitting unit 330 may perform a function of emitting light according to the control signal received by the information receiving unit 320.

The light-emitting unit 330 may include one or more light source elements, and the light source may include a light emitting diode (LED). Also, the light-emitting unit 330 may include LEDs of different colors; for example, the light-emitting unit 330 may include at least one of a red LED, a green LED, a blue LED, or a white LED.

When the light emitted from each of these LEDs is mixed, a wide range of colors may be created, and the mixed color is determined based on the ratio of the intensities of light emitted from each LED, where the intensity of light emitted from each LED may be proportional to the driving current of the LED.

A plurality of LEDs included in the light-emitting unit 330 may be arranged in the form of dots, where a specific word (text), image, or video may be displayed as the plurality of LEDs are selectively turned on or off according to the control of the processor 390 described later.

In the description above, an LED is used as a light source of the light-emitting unit 330, but the type of light source is not limited to the LED. According to another embodiment, an organic light emitting diode (OLED) may also be used as the light source.

The storage unit 340 may store one or more of various application programs, applications, data, and instructions for providing the light emission control service environment.

In addition, the storage unit 340 may store data received from or generated by other components of a performance production system. The storage unit 240 may be, for example, one of various storage devices such as a ROM, an EPROM, a flash drive, a hard drive and/or a USB drive, and may include a memory, a cache, and a buffer.

In an embodiment, the storage unit 340 may pre-store the information necessary to perform a light emission function of the light-emitting device 300.

In addition, the storage unit 340 may store at least one piece of production data and/or light emission pattern information that specifies the light emission form in which the light-emitting device 300 operates.

Furthermore, in an embodiment, the storage unit 340 may store information necessary to perform the light emission control service.

The battery 350 may receive external and/or internal power under the control of the processor 390 to supply the power required to operate each component of the light-emitting device 300.

The battery 350 may further include a DC/DC converter capable of converting the received power to a voltage level that may be used by the payloads of the light-emitting device 300.

In addition, the battery 350 includes at least one battery cell. Each battery cell is not particularly limited to a specific type as long as the battery cell may be repeatedly charged and discharged, such as a lithium-ion cell.

The charging unit 360 may include a wired and wireless charging module for providing a wired and wireless charging process for supplying the power required for the operation of the light-emitting device 300.

The sensor unit 370 may include at least one of a position sensor (IMU), an acceleration sensor, a gyro sensor, a distance sensor, a proximity sensor, a contact sensor, or an illumination sensing sensor.

Specifically, the position sensor (IMU) included in the sensor unit 370 may sense at least one of motion or acceleration of the light-emitting device 300. For example, the position sensor may be implemented as a combination of various position sensors such as an accelerometer, a gyroscope, and a magnetometer.

The input interface 380 may sense the input (for example, a gesture, actuation of a button, or other types of inputs) of a user (for example, audience using the light-emitting device 300) related to the light emission control service.

Specifically, the input interface 380 may include a predetermined button and/or a touch sensor.

In addition, the input interface 380 may be connected to an external controller to receive the input of the user.

The processor 390 may perform the overall operation such as power supply control of the light-emitting device 300 and a data processing function of controlling a signal flow between internal configurations of the light-emitting device 300 and processing data. The processor 390 may include at least one processor.

In addition, the processor 390 may communicate with each component internally through a system bus and may include one or more predetermined bus structures including a local bus.

In addition, the processor 390 may be implemented by using at least one of the ASICs, DSPs, DSPDs, PLDs, FPGAs, controllers, micro-controllers, microprocessors, or electric units for performing other functions.

In an embodiment, the processor 390 may control the light emission pattern of the light output from the light-emitting unit 330 by controlling the driving current of each LED of the light-emitting unit 330.

Thus, in an embodiment, the processor 390 may control the light-emitting device 300 including a plurality of LEDs and may form a predetermined text, image, or video.

The light-emitting device 300 including the above configuration may operate according to at least one piece of data stored in the storage unit 340 under the control of the processor 390.

In addition, in an embodiment, the light-emitting device 300 may emit light according to the control signal received from the central control terminal 100, a predetermined repeater, and/or a transmitter based on the light-emitting unit 330.

In this connection, the control signal may include command data that is activated to emit light based on production data pre-stored in the light-emitting device 300 or light emission pattern information included in the control signal.

Furthermore, in an embodiment, the light-emitting device 300 may sense motion and acceleration of the light-emitting device 300 based on the sensor unit 370.

Furthermore, in an embodiment, the light-emitting device 300 may recognize ambient sounds based on the sensor unit 370 and control light emission to match the recognized sounds. For example, the louder the recognized sound, the brighter the light emission.

Furthermore, in an embodiment, the light-emitting device 300 may transfer data sensed by the sensor unit 370 and/or the input interface to another device (for example, the central control terminal 100).

Furthermore, in an embodiment, the light-emitting device 300 may operate passively based on a command signal (control signal) delivered from the outside. In another embodiment, the light-emitting device 300 may operate on its own based on the input interface 380 (for example, a predetermined button).

The concept of operation may vary and is not limited to any one concept. For example, various types of operation are possible depending on the type of light-emitting device 300 (for example, cheering stick, light-emitting device, lighting stick, wearable band, and/or wearable device), such as light-emitting operation, sound-generating operation, and mechanical operation.

Furthermore, in another embodiment, the light-emitting device 300 may emit light according to the light emission pattern information of the production data pre-stored as a default for each light-emitting device 300.

Furthermore, in another embodiment, the light-emitting device 300 may directly obtain the BPM information using the BPM tracker and analyze the BPM.

Furthermore, in another embodiment, the light-emitting device 300 may adjust the speed of the light emission pattern by adjusting the speed of the light emission information based on the analyzed BPM information.

As described above, various embodiments may exist. In the following description, unless otherwise specified, the light-emitting device 300 will mainly be described in connection with the third embodiment, in which the device operates according to a control signal from the central control terminal 100. However, the description may also refer to the first and second embodiments where appropriate.

### Method for Controlling Light Emission Speed for Light-Emitting Device

The light-emitting device 300 according to various embodiments of the present disclosure may emit light according to the light emission speed control service provided by the central control terminal 100.

In this connection, the components mounted on the light-emitting device 300 may vary depending on various embodiments of the present disclosure, and thus the method of implementing light emission may vary depending on the light-emitting device 300 according to each embodiment.

In a first embodiment, the processor 390 of the light-emitting device 300 directly acquires and recognizes sounds output at a field, determines production data matching the recognized sound from among pre-stored production data, and adjusts the light emission speed according to the speed of the recognized sound.

To this end, the light-emitting device 300 according to the first embodiment may be mounted with a sound analysis engine for recognizing field sounds, the light emission control assembly 180 including the BPM tracker, and/or a high-capacity memory for pre-storing a plurality of pieces of production data.

In other words, the light-emitting device 300 according to the first embodiment may be a device mounted with functions for recognizing sounds output at a field, measuring the speed of the recognized sound, and/or performing speed adjustment computations for a light emission pattern based on the measured sound speed.

Accordingly, the light-emitting device 300 according to the first embodiment provides an advanced cheering experience by autonomously controlling and/or outputting an optimized light emission pattern based on the type and/or BPM of the recognized sound.

In a second embodiment, the light-emitting device 300 does not include the sound analysis engine for recognizing field sounds, but may adjust the light emission speed based on information provided by the central control terminal 100.

To this end, the light-emitting device 300 according to the second embodiment may be mounted with a memory that pre-stores a plurality of pieces of production data, thereby determining specific production data based on instructions received from the central control terminal 100.

In other words, the light-emitting device 300 according to the second embodiment may be a device mounted with a function for performing speed adjustment computations for a light emission pattern.

Accordingly, the light-emitting device 300 according to the second embodiment may implement synchronized light emission production while being relatively simpler and less expensive than the first embodiment.

In a third embodiment, the light-emitting device 300 may receive information previously determined based on sound analysis and light emission pattern speed adjustment performed by the central control terminal 100 and operate passively according to the received information.

Accordingly, the light-emitting device 300 according to the third embodiment may construct a low-cost and low-power cheering system using only a simple wireless communication module and a basic driving circuit.

Hereinafter, the light-emitting device 300 according to the third embodiment of the above embodiments will be described based on the light emission according to the light emission control service provided by the central control terminal 100.

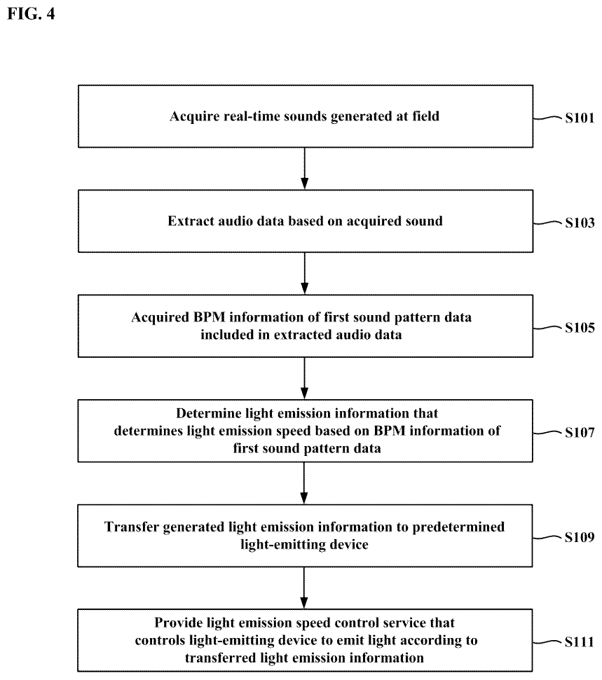

Hereinafter, a method for controlling the light emission speed of the light-emitting device 300 to provide the light emission speed control service by the application 111 executed by the at least one processor of the central control terminal 100 according to an embodiment of the present disclosure will be described in detail with reference to the attached FIGS. 4 to 8.

In an embodiment of the present disclosure, the at least one processor of the central control terminal 100 may execute at least one application 111 stored in at least one memory 110 or operate in a background state.

Hereinafter, the method of controlling the light emission speed of the light-emitting device 300 described above by the at least one processor operating to execute the instructions of the application 111 will be briefly described as being performed by the application 111.

FIG. 4 is a flowchart illustrating a method for controlling a light emission speed of the light-emitting device 300 according to an embodiment of the present disclosure.

Referring to FIG. 4, in an embodiment, the application 111 may acquire real-time sounds generated at a field (S101).

In detail, in an embodiment, the application 111 may acquire real-time sounds based on sound collection microphones disposed at various locations at a field.

Herein, the sounds according to an embodiment may encompass various sounds output at the site of a sports game, including game-related main sound sources, audience participation and sounds that encourage cheering, stadium operation-related voices and sound effects, special effects, and theme songs.

For example, the sounds acquired in real-time may include cheering songs for individual players, cheering songs for teams, songs to celebrate victory, and consolation songs for defeat.

These sounds may include a first source, which is sound actually output from a sound system installed at a field, and/or a second source, which is sound streamed in an audio file format (for example, mp3, mp4, wav, and/or flac) within the central control terminal 100.

In this connection, when the central control terminal 100 does not have a downloaded sound file or a streaming sound file, the first source may be automatically sensed.

In other words, in an embodiment, the application 111 may acquire real-time sound, including the first and second sources, based on the sound collection microphone, the central control terminal 100, and/or an external device.

In addition, in an embodiment, the application 111 may extract audio data based on the acquired sound (S103).

Herein, the audio data according to an embodiment may refer to data having a predetermined meaning from the sounds included in the sound.

In detail, in an embodiment, the audio data may be at least one of a sound source related to a sports game, a cheering song, a sound effect, an alarm sound, and/or the voice of a person leading the sports game, or words and/or sentences included therein.

The audio data may be classified into sound pattern data and/or verbal data.

The sound pattern data may refer to data having a predetermined sound pattern in music and sound tracks of predetermined music files, such as background music, cheering songs, theme songs, and cheering songs for each player, directly or indirectly related to a sports game among audio data.

The verbal data may refer to the voices of persons related to a sports game (for example, hosts, commentators, stadium announcers, or announcements) and words or sentences included therein.

The audio data including the sound pattern data and verbal data may be pre-stored in a database. The audio data not pre-stored in the database may be automatically assigned semantic information or title information through a sound analysis process and stored in the database.

To analyze sound, in an embodiment, the application 111 may amplify the acquired sound using a sound amplifier, repeater, and/or antenna included in the light emission control assembly 180.

In addition, in an embodiment, the application 111 may perform preprocessing to remove noise from the acquired sound based on a noise removal algorithm utilizing noise cancellation and/or filtering.

In addition, in an embodiment, the application 111 may extract audio data by analyzing the noise-removed sound based on a predetermined deep learning model and/or algorithm.

In this connection, in an embodiment, the application 111 may analyze the noise-removed sound to extract sound features and keywords within the sound, and extract audio data by filtering data within a database that matches the features and keywords.

For example, the application 111 may extract sound features based on a music editing program such as Audacity, a specialized tag editing tool such as Mp3tag or Kid3, or a BPM automatic analysis program such as a digital audio workstation (DAW).

In addition, the application 111 may detect audio data by extracting sound features (for example, waveforms) based on a deep learning model (for example, CNN, RNN, Transformer-based) pre-trained with an audio dataset.

For example, the application 111 may extract features of time-frequency domain from sound utilizing mel-frequency cepstral coefficients (MFCCs), spectrograms, or waveform patterns.

The audio dataset utilized during the pre-training of the deep learning model may include audio data (in other words, sound pattern data) based on sound sources with a predetermined waveform and/or audio data containing at least one word with a predetermined meaning (in other words, verbal data) in a plural number.

In addition, the audio dataset may be a training dataset including sounds containing audio data and a plurality of parameters labeled with the audio data.

In an embodiment, such sound pattern data may be pre-stored in a database, labeled with meaning, name, and/or title describing the corresponding sound source. The title may be manually determined by a sound source processor or automatically assigned and determined through word sensing within the system.

In this connection, when the sound pattern data has been previously provided with information (for example, BPM information and/or light emission pattern information) by a client, the relevant information may be stored in a metadata format pre-matched to an audio file (for example, mp3, wav, or flac).

In detail, in an embodiment, the application 111 may store BPM information, in which different BPMs are tagged for each predetermined section included in the sound pattern data, by matching the same with the sound pattern data.

For example, the sound pattern data in the metadata format may be in a format where BPM information, output by performing automatic BPM analysis of a sound file using a music editing program, is inserted into the sound pattern data.

In addition, in an embodiment, the application 111 may store different pieces of light emission pattern information (specifically, light emission color) for each team corresponding to the sound pattern data by matching the same with the sound pattern data.

Here, the light emission pattern information according to an embodiment may refer to information defining a light emission form in which the light-emitting device 300 operates according to light emission pattern components including a light emission mode (for example, ON mode, OFF mode, and/or sound recognition mode), light emission color, light emission time, light emission brightness, light emission effect, and light emission speed.

To this end, in an embodiment, the application 111 may acquire team name information corresponding to the sound pattern data.

In addition, in an embodiment, the application 111 may determine a light emission color component of the light emission pattern information of the sound pattern data based on the acquired team name information.

The team name information and the resultant light emission pattern information may have been previously matched to the relevant file by a sound source provider. Alternatively, in an embodiment, the application 111 may link to a predetermined server to search for the relevant sound pattern data to determine which team the sound source is for, and match the relevant file based on the search result.

For example, when the sound pattern data in the metadata format is recognized as a cheering song for the “Samsung Lions,” the light emission pattern information that determines “blue,” which is the signature color of the team, as the light emission color component may be inserted into the sound pattern data.

In other words, the sound pattern data in the metadata format may be matched with title information and previously provided information (for example, BPM information and/or light emission pattern information).

In this connection, in an embodiment, the application 111 may train a deep learning model with the metadata and the sound containing the metadata, thereby updating the deep learning model to enable complex situation recognition during sound analysis.

In the case of sound pattern data in the metadata format, in an embodiment, the application 111 may preferentially reference and reflect the information included in the metadata to determine the light emission pattern component.

In another embodiment, the sound pattern data may be matched only with the title information, without any previously provided information. In this connection, the application 111 may perform a process of determining the light emission pattern information, including light emission speed, color, and pattern to correspond to the relevant sound pattern data.

Hereinafter, for convenience of description, the description will be made assuming that the audio data is the sound pattern data.

In addition, in an embodiment, the application 111 may acquire BPM information of the first sound pattern data included in the extracted audio data (S105).

In detail, in an embodiment, the application 111 may acquire the BPM information by extracting BPM information pre-matched to the first sound pattern data included in the extracted audio data, or by directly determining BPM information based on the light emission control assembly 180.

Referring to the above, in an embodiment, at least one of title information, BPM information, and/or light emission information may be pre-matched to the first sound pattern data.

In this connection, in an embodiment, the BPM information may refer to feature information, such as the tempo and/or beat of a sound source.

For example, when the first sound pattern data is a ballad, the BPM information of the first sound pattern data may include a value between 60 and 90. In contrast, when the first sound pattern data is a dance song, the BPM information of the first sound pattern data may include a value between 120 and 140. The first sound pattern data does not include only one piece of BPM information. Depending on the variation of the sound source, a plurality of pieces of BPM information may be included in a single sound source.

In addition, in an embodiment, the BPM information may further include spectral characteristics comparing the volume of the sound source, and the emphasis of low and high tones.

In an embodiment, the application 111 may determine the first sound pattern data among the sound pattern data pre-stored in the database, wherein the similarity with the extracted audio data exceeds a preset reference.

In this connection, in an embodiment, the application 111 may compare waveforms of sound pattern data based on similarity of features and/or feature vectors in the time axis and frequency band.

When, as a result of the search, sound pattern data matching the analyzed waveform exists among sound sources pre-stored in the database, the relevant sound pattern data may be extracted.

In other words, in an embodiment, when the BPM information previously matched to the first sound pattern data included in the extracted audio data exists, the application 111 may acquire the BPM information simply by reading the matched BPM information.

In an embodiment, the application 111 may directly determine BPM information by performing BPM information work that tags the BPM value calculated through the BPM tracker of the light emission control assembly 180 to the first sound pattern data, thereby obtaining the BPM information.

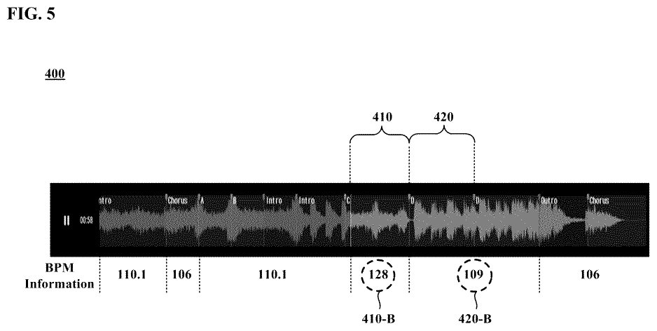

FIG. 5 is a diagram illustrating BPM information work for audio data according to an embodiment of the present disclosure.

Referring to FIG. 5, in an embodiment, the application 111 may acquire the BPM information by performing the BPM information work based on the analysis results of first audio data 400 acquired based on a predetermined BPM automatic analysis program and/or algorithm.

In detail, in an embodiment, the application 111 may tag the BPM value included in the output data output from the predetermined BPM automatic analysis program and/or algorithm as BPM information to first sound pattern data 410 included in the first audio data 400.

In this connection, in an embodiment, when the first BPM value is maintained and a change in the second BPM value is sensed, the application 111 may determine the section where the first BPM value is maintained as the first sound pattern data 410, and determine the section where the second BPM value is maintained as second sound pattern data 420.

Accordingly, one piece of audio data may be classified into a plurality of sections (in an embodiment, sound pattern data), and each section may be tagged with one piece of BPM information.

For example, the first sound pattern data 410 may be tagged with first BPM information 410-B of 128 BPM, and the second sound pattern data 420 may be tagged with second BPM information 420-B of 109 BPM.

In addition, in an embodiment, the application 111 may additionally tag, store and manage additional information, including BPM change information, volume change information, genre information, and features (for example, name or theme) for each piece of sound pattern data for the entire first audio data 400, to the first audio data 400 and/or at least one piece of sound pattern data.

For example, when the first sound pattern data 410 is a chorus section, additional information such as “Name=Chorus,” “Energy=High,” and “Feature=Highlight” may be tagged to emphasize that the relevant section is the brightest and most energetic highlight portion of the sound pattern data.

In this manner, in an embodiment, the application 111 may tag measured BPM values for each of a plurality of sections included in the first audio data as BPM information.

In addition, in an embodiment, the application 111 may set the BPM information tagged to the first sound pattern data played at a higher frequency than a preset reference on a sound source as representative BPM information for the first audio data 400.

The light-emitting device 300 according to an embodiment may acquire BPM information using a first method of acquiring BPM information from the application 111 and a second method of acquiring BPM information by the light-emitting device 300 by measuring the BPM. In this connection, when BPM information is acquired using both methods, the BPM information acquired using the first method may be given priority and light may be emitted accordingly.

For example, when the first sound pattern data 410 is a section that is played particularly frequently on the first audio data 400, such as “Republic of Korea clap clap clap clap clap,” the application 111 may set the first BPM information 410-B, which is a BPM tag tagged to the first sound pattern data 410, as a representative BPM tag of the first audio data 400.

In addition, in an embodiment, the application 111 may determine light emission information that determines the light emission speed based on the BPM information of the first sound pattern data (S107).

In detail, in an embodiment, the application 111 may acquire BPM information that is set differently for each of a plurality of sections included in the first audio data 400, and adjust the light emission speed based on the acquired BPM information to generate the light emission information that specifies the light emission form of the light-emitting device 300. In this specification, the term “section” may be used as a meaning corresponding to one piece of sound pattern data.

To this end, in an embodiment, the light emission information may have a predetermined data structure that specifies each of the light emission pattern components.

In detail, in an embodiment, the light emission information may include light emission pattern information, including section information, color, effect, and light emission time, and/or light emission speed information. In other words, the light emission pattern information is included in the light emission information.

More specifically, in an embodiment, light emission information 500 may include at least one of section information, light emission pattern information, and/or light emission speed information. In addition, in another embodiment, the light emission speed information may be directly generated by the light-emitting device 300.

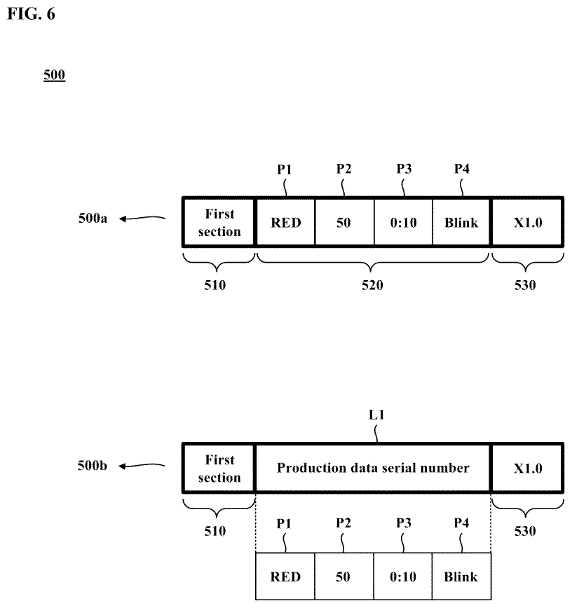

FIG. 6 is a diagram illustrating light emission information including section information and light emission pattern information according to an embodiment of the present disclosure.

Referring to FIG. 6, in an embodiment, the light emission information 500 may include section information 510 and/or light emission pattern information 520.

The section information 510 may be textual information indicating a predetermined time (for example, seconds) indicating which portion of the first audio data 400 the relevant section corresponds to, and/or information defining the name of the relevant portion.

For example, the application 111 may acquire the section information 510 defined as “Oh victorious Korea 0:00-0:10” instead of the first sound pattern data 410 from the first audio data 400 titled “Oh victorious Korea.”

In addition, in an embodiment, the section information 510 may further indicate information related to the situation tag (for example, a section of the sound source and/or a section of the game). This will be described later.

The light emission pattern information 520 may be information determining the components of the light emission pattern of the relevant section (in an embodiment, light emission color, light emission time, light emission brightness, light emission effect, and light emission speed).

The light emission color may be expressed by assigning a series of numbers to preset color-specific channel values through computations. For example, a large difference in the color-specific channel values may result in a highly saturated color, while a small difference in the color-specific channel values may result in a less saturated color.

As another example, the light emission color may be expressed as a preset color code (for example, red, blue, or purple) representing a predetermined color. As yet another example, the light emission color may be expressed as a serial number pre-assigned to each predetermined color for convenience or security. In addition, when a team has a unique color, the unique color may be automatically determined as the light emission color when determining the light emission pattern information 520 for that relevant team.

For convenience of description, in the examples described below, the light emission colors are described based on the color codes preset in the alphabet.

The light emission time may be expressed as a time value, with values such as 0:01, 0:02, . . . , m:s, with higher values indicating a longer length of time. In addition, the light emission brightness may be expressed as a brightness value with values of 0, 1, 2, . . . n, with higher values indicating brighter brightness.

The light emission effect may refer to a light emission form in which the components are set to change within a predetermined time to create a dynamic visual effect. The light emission effect may be expressed by effect names (for example, blink, gradation, fade in, fade out) or unique values indicating each effect.

For example, the light emission effect may include 1) a blinking effect that quickly flashes a light-emitting unit 330 by setting the light emission differently for each time zone within a predetermined period of time, 2) a gradation effect in which the light emission color is set differently for each time zone within a predetermined period of time and gradually changes, and 3) a fade in/out effect in which the brightness gradually decreases or brightens for each time zone.

In an embodiment, the light emission pattern information 520 may include at least one light emission pattern component P1, P2, P3, and P4.

In an embodiment, the application 111 may determine the light emission pattern by inserting a predetermined value representing the light emission pattern into these light emission pattern components P1, P2, P3, and P4.

For convenience of description, each light emission pattern component P1, P2, P3, and P4 is described as having a one-to-one (1:1) correspondence with one light emission pattern component, for a total of five. However, the number thereof may be greater or less than the number shown.

In detail, each light emission pattern component P1, P2, P3, and P4 may be inserted with information representing the light emission pattern components, including light emission color, light emission brightness, light emission time, and/or light emission effect, as values that the light-emitting device 300 may implement.

In other words, referring to the illustration, first light emission pattern information 500a may be in a format in which the values of the light emission pattern components are determined, such as “RED/50/0:10/Blink/×1.0.”

In addition, the light emission pattern components P1, P2, P3, and P4 included in the light emission pattern information 520 may have their respective values determined in advance and pre-stored as production data in each light-emitting device 300. Accordingly, the light emission pattern components may be determined by a production data serial number indicating the relevant production data.

Referring again to the illustration, second light emission pattern information 500b may be in a format in which “RED/50/0:10/Blink” already exists as one piece of first production data L1, and an index number, such as “001,” which is the production data serial number of the first production data L1, is determined

In other words, in an embodiment, the production data may refer to a data set that pre-specifies resources of frequently used light emission patterns.

For example, the production data may be pre-stored in the system as a library, and predetermined performance scenes or group information may be tagged and stored.

The production data is stored in the light-emitting device 300 by default without a separate download process, allowing it to be executed automatically and/or manually upon acquiring a control signal or input of a user using the light-emitting device 300.

In addition, the light emission pattern components included in the production data do not necessarily need to be used identically. The light emission effect may also be generated and utilized by applying existing production data through dynamic parameter adjustments that change at least one light emission pattern component included in the production data under the control of an administrator.

In addition, the light emission speed information may be information that determines the light emission speed of the light emission pattern information 520 based on the acquired BPM information. Simply put, the light emission speed information may be the light emission speed proportional to the BPM information.

The light emission speed information may be expressed as a repetition frequency per second or a playback speed rate of the light emission pattern information 520. For example, the default light emission speed information is ×1.0, and the playback speed rate may increase as the speed increases. Herein, the light emission speed information according to an embodiment may be information defining the flashing cycle (for example, flashing frequency and flashing duty cycle), flashing effect cycle (for example, fade in/out cycle and gradient transition speed), looping interval, section-by-section speed change setting information, and/or weighting information of the light-emitting device 300.

Herein, the weighting information according to an embodiment may be information determining which BPM information generated by an entity is to be given priority, depending on the entity acquiring the BPM information of at least one piece of sound pattern data included in the first audio data 400.

For example, among the BPM information generated by the central control terminal 100 and the BPM information generated by the light-emitting device 300, a predetermined weighting value may be assigned to the former BPM information. This means that when the two types of information coexist, the light emission speed information is determined based on the former BPM information. Hereinafter, the description will be made based on the BPM information generated by the central control terminal 100 being pre-assigned with weighting information.

The light emission information 500 according to an embodiment includes the section information 510 and the light emission pattern information 520, but may not include the light emission speed information depending on the entity adjusting the light emission speed (for example, the central control terminal 100 and/or the light-emitting device 300). In this connection, the application 111 may perform a process of acquiring the light emission information 500 based on whether the light-emitting device 300 includes a function for performing a speed adjustment computation of the light emission pattern information 520.

Returning to the above, in an embodiment, the application 111 may determine the light emission pattern information 520 based on the acquired BPM information.

In this connection, when the light emission pattern information 520 and/or the production data are pre-matched to the relevant first audio data and/or first sound pattern data 410 for which the BPM information is acquired, the application 111 in an embodiment may extract and determine the pre-matched light emission pattern information 520.

In addition, in an embodiment, the application 111 may determine the light emission pattern information 520 based on a mapping table (MT) and/or rule set that corresponds the light emission pattern information 520 and/or the production data by BPM range (or BPM section).

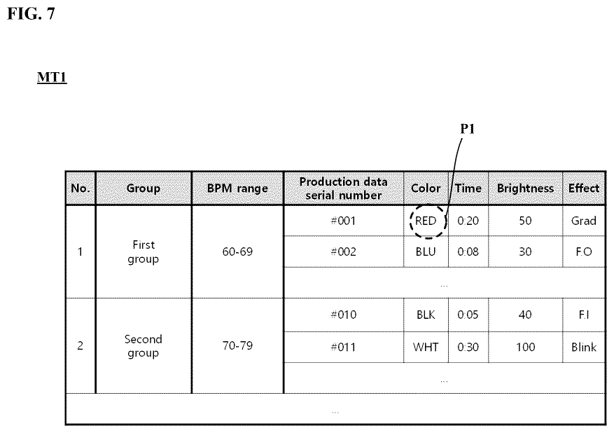

FIG. 7 is an example of a first mapping table corresponding to BPM range-specific light emission pattern information according to an embodiment of the present disclosure.

Referring to FIG. 7, in an embodiment, the application 111 may determine the light emission pattern information 520 based on a first mapping table MT1 that corresponds at least one light emission pattern component to each BPM range.

The BPM range may refer to a grouping of specific BPM ranges. In other words, minimum and maximum BPM values are preset, and the range of the next group may be set based on the difference between those values. Each BPM range may be classified into groups.

In addition, in an embodiment, the application 111 may determine the first light emission pattern information among at least one piece of light emission pattern information 520 included in the BPM range to which the acquired BPM information belongs.

In this connection, the first light emission pattern information may be determined using a random determination process or based on a predetermined artificial intelligence model that automatically recommends the most appropriate light emission pattern information 520 based on the first mapping table MT1.

To this end, in an embodiment, the application 111 may determine the light emission pattern information 520 based on a trained light emission pattern determination artificial intelligence model that provides a predetermined audio dataset as input data and provides the first light emission pattern information most appropriate for the acquired BPM information as output data.

In addition, in the embodiment, the application 111 may also change at least one parameter (in an embodiment, the light emission pattern component) included in the determined light emission pattern information 520.

For example, when the light emission color component is sound pattern data in a preset metadata format, even when the first production data (#001) is determined as the light emission pattern information 520, the light emission color component P1 of the first production data (#001) may be changed to the light emission color preset in the sound pattern data in the metadata format.

In other words, in an embodiment, the application 111 may determine the light emission pattern information 520 based on the acquired BPM information using a random determination process and/or a preset artificial intelligence model.

Specifically, in an embodiment, the application 111 may determine the first light emission pattern information in real time using a predetermined light emission pattern generation deep learning model and/or algorithm that analyzes BPM information for each section, instruments prominently played in the relevant section, frequency band-specific increases and decreases, and/or sound pressure.

For example, the application 111 may generate and produce the light emission speed information such that the flashing speed slows down along with the BPM for each section and/or the progression of a song, such that the interval increases by 10% for every n-th blink.

In addition, the application 111 may acquire and produce the light emission color and/or light emission brightness when sound pressure and/or spectral energy are detected to exceed a preset reference using the light emission pattern generation deep learning model and/or algorithm.

For example, in a chorus where the performance of the bass drum is prominent, the application 111 may determine the light emission information 500 that sets the light emission color to a cool color (for example, blue and/or purple), the light emission effect to a blinking effect, the brightness to increase by 10%, and/or the light emission speed information 530 to increase the flashing speed by decreasing the interval by 10% for every fifth blink, depending on the frequency sound range of the bass drum.

In addition, in an embodiment, the application 111 may determine light emission speed information based on the acquired BPM information.

To this end, in an embodiment, the application 111 may determine light emission speed information based on a predetermined formula that calculates a light emission speed value proportional to the BPM information value.

For example, the formula for calculating the light emission speed value may be “light emission speed (T)=60 (sec)/BPM value.” Specifically, when the BPM value is 60, the light emission speed value may be ×1.0. When the BPM value is 120, the light emission speed value may be ×2.0.

Through the aforementioned process, in an embodiment, the application 111 may generate the light emission information 500 that determines the section information 510 and/or the light emission pattern information 520 based on the acquired BPM information.

The light emission information 500 may set only one piece thereof to the first audio data 400 based on representative BPM information, or set a plurality of pieces thereof to the first audio data 400 based on the BPM information that is differently matched to each section included in the first audio data 400.

In the latter case, the light emission information 500 matching the changed section may be generated each time a section change is sensed.

In addition, in an embodiment, the application 111 may update the database to reorganize the light emission information 500 for the relevant audio data according to additions, changes, and deletions of the audio data.

For example, the application 111 may continuously update the database by newly storing sound pattern data for newly recruited or retired players, or by adding, changing, and/or deleting the section information 510 and the light emission pattern information 520 matching new teams.

In addition, the light emission pattern information 520 included in the light emission information 500 does not necessarily need to be used identically. Additional light effects may be generated and utilized by applying the existing light emission information 500 through additional control that changes at least one piece of light emission pattern information 520 included in the light emission information 500 under the control of an administrator.

In addition, in an embodiment, the application 111 may transfer the generated light emission information to a predetermined light-emitting device (S109).

In detail, in an embodiment, the application 111 may transfer a control signal including the determined light emission pattern information 520 to the plurality of light-emitting devices 300 located at a field in a one-to-many manner using a predetermined wireless communication method.

For example, the application 111 may transmit a control signal to at least one light-emitting device 300 using a broadcasting method (an all-to-all communication method that delivers traffic to an unspecified number of recipients without specifying a recipient).

More specifically, in an embodiment, the application 111 may transmit a control signal to the light-emitting devices 300 located nearby using a preset broadcasting protocol. The light-emitting devices 300 located nearby and set to receive broadcast signals using the preset broadcasting protocol may receive the transmitted control signal, and the light-emitting devices 300 may operate according to the received control signal.

In this connection, the preset broadcasting protocol may refer to a frequency band, a control signal encoding/decoding method. To this end, the central control terminal 100 may include a broadcast transmitter. In addition, the broadcasting transmitter, including an exciter composed of an oscillator and a modulator, may modulate a control signal generated by the central control terminal 100 into radio waves of a frequency band determined according to the preset broadcasting protocol and transmit an RF signal through an antenna.

Accordingly, the light-emitting devices 300 set to receive a control signal of the preset broadcasting protocol may receive the light emission pattern information 520 included in the control signal transmitted from the central control terminal 100.

In addition, in an embodiment, the application 111 may provide the light emission speed control service that controls the light-emitting device to emit light according to the transferred light emission information (S111).

Herein, in an embodiment, the light emission speed control service may refer to a service that controls the light emission speed of the light-emitting device 300 according to the audio sensed at a field based on the central control terminal 100.

In detail, in an embodiment, the light emission speed control service may include all services related to light emission that controls the light-emitting device 300 to emit light according to the first, second and third embodiments.

In the first embodiment, the light-emitting device 300 directly acquires and recognizes sound output at a field and emits light. Upon acquiring the light emission pattern information 520 from the central control terminal 100, the light-emitting device 300 may emit light using the acquired light emission pattern information 520.

In the second embodiment, the light-emitting device 300 reads the production data included in the light emission pattern information 520 acquired from the central control terminal 100, and adjusts the light emission pattern speed using the production data according to the light emission speed included in the light emission pattern information 520 to emit light.

In the third embodiment, the light-emitting device 300 may emit light according to the light emission pattern information 520 acquired from the central control terminal 100. In this connection, when the light emission speed changes, the central control terminal 100 may convert and retransfer a control signal to include the light emission pattern information 520 with the changed light emission speed.

Herein, in an embodiment, the light-emitting device 300 may operate the production data and emit light according to a control signal including a control command that activates pre-stored production data.

In detail, the light-emitting device 300 according to various embodiments may emit light according to the transferred light emission pattern information 520 by reading and activating the first production data matching the production data included in the control command from the storage unit.

To summarize the above process, in an embodiment, the application 111 may tag BPM information for each section of the first audio data 400.

In addition, in an embodiment, the application 111 may set BPM information tagged to the first sound pattern data 410 of the first audio data 400 played at a frequency higher than a preset reference as the representative BPM information.

In detail, in an embodiment, the application 111 may determine the light emission speed information based on the representative BPM information and/or the BPM information for each section, thereby controlling the speed of the light emission pattern information 520.

For example, the light-emitting device 300 may directly measure and analyze the BPM value for the section information 510 to detect the light emission speed information 530. In this connection, the light-emitting device 300 may determine the light emission speed information 530 of first light emission information 501 and emit light using at least one of the first mapping table MT1 including the light emission pattern information 520 pre-matched to the section information 510 and/or the BPM automatic analysis deep learning model and/or algorithm.

As such, the application 111 may provide the light emission speed control service in which the light-emitting device 300 emits light in the first sound pattern data 410 for 5 seconds based on the first light emission information 501, including the light emission pattern information 520 “RED/50/0:05/All On” pre-matched to the first sound pattern data 410 of the “Oh victorious Korea” sound source, and the detected light emission speed information 530.

In this connection, the section information 510 of the first sound pattern data 410 may be further displayed as BPM information, the start and end times of the section indicated by a timestamp, and/or the name of a specific section (for example, “1st section” or “2nd section”).

Herein, the application 111 may perform a process of directly measuring and/or analyzing the BPM information to detect the light emission speed information 530, thereby providing the light emission speed control service in which the light-emitting device 300 emits light.

In another embodiment, the application 111 may provide the light emission speed control service in which the light-emitting device 300 emits light according to the light emission information 500 including the light emission pattern information 520 that is pre-matched to the first sound pattern data 410 of the first audio data 400.

For example, the application 111 may provide the light emission speed control service in which the light-emitting device 300 emits light according to second light emission information 502 including the second sound pattern data 420 when the second sound pattern data 420 of “Oh victorious Korea” is output as a sound source. Herein, when the second sound pattern data 420 corresponds to a section from 10 to 20 seconds of the “Oh victorious Korea” sound source, the light-emitting device 300 may emit light for a section of 0:20 (for example, 10 seconds) based on “Second section/RED/50/0:10/Blink/Blink twice per second,” which is the second light emission information 502.

In another embodiment, the application 111 may sense ambient sound and provide the light emission speed control service for the light-emitting device 300 to emit light according to a game situation.

Herein, the ambient sound according to an embodiment may refer to sounds other than the first audio data 400 detected from the audio data.

In detail, in an embodiment, the application 111 may determine the ambient sound as the sound source upon sensing a sound volume exceeding a preset reference even when the first audio data 400 is detected.

In another embodiment, the application 111 may sense changes in ambient sound due to a specific game event, which is an event related to a game that elicits an audience response, and provide the light emission speed control service in which the light-emitting device 300 emits light based on third light emission information 503 including the section information 510 of relevant ambient sound.

In addition, in an embodiment, the application 111 may provide the light emission speed control service in which the light-emitting device 300 emits light based on the section information 510 of a plurality of pieces of light emission information 500 acquired from the first sound pattern data.

For example, when two pieces of light emission information 500 are acquired from the first audio data 400, the application 111 may emit light with a color of red, a brightness of 50, a duration of 5 seconds, a light emission effect of an All On effect, and/or a looping cycle of 1 second, in which the section information 510 corresponds to the light emission information 500 of “Oh victorious Korea 0:00.” In addition, sequentially, the application 111 may emit light with a color of red, a brightness of 50, a duration of 5 seconds, a light emission effect of blinking effect, and/or gradually accelerating, in which the section information 510 is pre-matched to the light emission information 500 of “Oh victorious Korea 0:10.”

In other words, in an embodiment, the light-emitting device 300 may sequentially then emit light in the order of the section information 510 even when acquiring the plurality of pieces of light emission information 500.

In addition, in an embodiment, the application 111 may further map timestamp information to the light emission information 500 to provide the light emission speed control service for the light-emitting device 300 to emit light.

In a more detailed embodiment, the application 111 may store game start, end, and/or specific section times in the timestamp information and control the light-emitting device 300 to emit light accordingly, thereby providing the light emission speed control service.

For example, when the game start time is 8:00 p.m., the application 111 may recognize that the game has started at the relevant time based on stored timestamp information and control the light-emitting device 300 to emit light based on the light emission information 500 corresponding to the game start, thereby further providing the light emission speed control service.

According to the aforementioned description, in an embodiment, when the application 111 determines the light emission information 500 based on the first audio data 400 and/or the first sound pattern data 410, it may control the light-emitting device 300 to repeatedly loop the first light emission pattern information and/or the first production data based on the light emission speed information reflecting the BPM information.

However, when a section with a specific rhythm exists within the sound pattern data, controlling the light-emitting device to emit light based only on one piece of light emission speed information matching the relevant section may be performed with somewhat inconsistent specific rhythms and light emission patterns, resulting in out-of-sync light emission pattern production.

For example, when the “Oh victorious Korea” section of a cheering song is repeated multiple times, simply producing BPM alone does not fully capture the distinct characteristics of the relevant rhythm. Accordingly, separate light emission production needs to be applied each time the section is played to maximize audience response.

In other words, beyond simply looping the production data at a preset light emission speed, there is a need to control the light-emitting device 300 to precisely match a specific rhythm sensed in a specific section of the sound source and emit light.

Accordingly, in an embodiment, when a specific rhythm is sensed, the application 111 may generate “section production information” rather than BPM information, and change the light emission information 500 based on the generated section production information.

The section production information, according to an embodiment, may refer to information that, when a specific rhythm occurs multiple times in the first audio data 400, exceptionally produces and specifies the light emission information 500 only when the relevant section is sensed. The section production information may be detected from the entire first audio data 400 or from the first sound pattern data 410. However, for convenience of description, the description will be made based on what is detected from the first sound pattern data 410.

In addition, the section production information according to an embodiment may be information that sets the light emission pattern information 520 included in the existing light emission information 500 to be played to a specific rhythm.

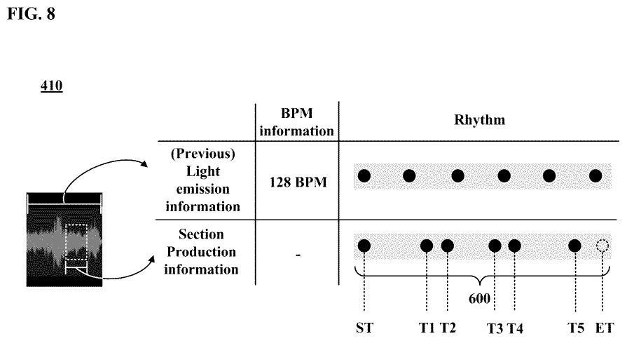

FIG. 8 is an example of a diagram illustrating section production information according to an embodiment of the present disclosure.

Referring to FIG. 8, in an embodiment, even in the case where BPM information is matched to the first sound pattern data 410, when a specific rhythm (hereinafter, “specific rhythm section 600”) defined in advance is detected, the application 111 may generate section production information that causes the light to be emitted using light emission information that prioritizes a specific rhythm (hereinafter, “specific rhythm light emission information”) instead of light emission information based on the BPM information previously matched to the first sound pattern data (hereinafter, “BPM light emission information”).

To this end, in an embodiment, the application 111 may detect the specific rhythm section 600 in which specific lyrics, a refrain, and/or a rhythm pattern appear in the first sound pattern data 410 based on a pre-trained deep learning model capable of performing sound source and/or voice analysis.

In addition, in an embodiment, the application 111 may determine a starting point ST and an ending point ET of the detected specific rhythm section 600.

In addition, in an embodiment, the application 111 may track syllable points T1, T2, T3, T4, and T5 where the sound of each syllable is recorded, starting from the starting point ST of the specific rhythm section 600.

Referring again to FIG. 8, in the illustrated specific rhythm section 600, “o,” “vic,” “torious,” “Ko,” “re,” and “a” may be tracked in order from the starting point ST, the first syllable point T1, the second syllable point T2, the third syllable point T3, the fourth syllable point T4, and the fifth syllable point T5. The ending point ET may be recorded as the point where the last syllable point ends.

In other words, in an embodiment, the application 111 may record a predetermined timestamp by determining the starting point ST, at least one syllable point T1, T2, T3, T4, and T5, and/or the ending point ET for the specific rhythm section 600.

Accordingly, in an embodiment, the application 111 may generate section production information that sets the light emission pattern information 520 matched to the first sound pattern data 410 to be played at a light emission timing corresponding to the recorded timestamp.

To synchronize with an actual field situation, in an embodiment, the application 111 may transfer a control command to the light-emitting device 300 to emit light with the generated section production information whenever the specific rhythm section 600 is sensed in real time.

In addition, in an embodiment, the application 111 may continuously update a list of the BPM information, the first mapping table MT1, and/or the light emission information 500 of the database and/or the storage unit 340 of the light-emitting device 300.

In addition, in an embodiment, the application 111 may further update the relevant database and/or the storage unit 340 of the light-emitting device 300 by transferring preset updates to the light-emitting device 300 and/or sharing the same via short-range wireless communication (for example, NFC, Bluetooth, or IR).

Accordingly, in an embodiment, the application 111 may re-control the light-emitting device 300 based on the section direction information that causes specific rhythm light emission information to emit light with priority over BPM light emission information, thereby providing audience members with an enhanced cheering experience that is difficult to achieve with simple BPM synchronization alone.

In the first and/or second embodiments, the light-emitting device 300 may acquire sound through at least one sound collection microphone. In addition, audio data may be extracted from the acquired sound. In addition, at least one of the light emission pattern information and production data matching the first sound pattern data included in the extracted audio data may be determined. In addition, the BPM information of the first sound pattern data may be calculated using a BPM tracker. In addition, a speed adjustment computation may be performed to cause at least one of the determined light emission pattern information and production data to emit light at a light emission speed based on the calculated BPM information.

While the aforementioned embodiment focused on controlling the light emission speed based on BPM information, which is a physical characteristic of the audio data, the application 111 according to yet another embodiment of the present disclosure may more precisely control the light emission pattern through a situation recognition process that understands the semantic context of sounds generated at a field. Beyond simple rhythm synchronization, this is to provide active cheering productions that match the game situation or the atmosphere of audience members.

### Method for Controlling Light Emission Pattern Based on Situation Recognition

Hereinafter, a situation recognition-based control process according to an embodiment of the present disclosure will be described. However, the acquisition of the sound (S101), the extraction of the audio data (S103), the transmission of the generated control signal (S109), and the controlling of the light-emitting device (S111) are substantially identical to each stage of the method for controlling the light emission speed described above with reference to FIG. 4. Accordingly, a detailed description thereof will be omitted, and the description will be made based on the situation recognition and light emission pattern determination processes (S105, S107).

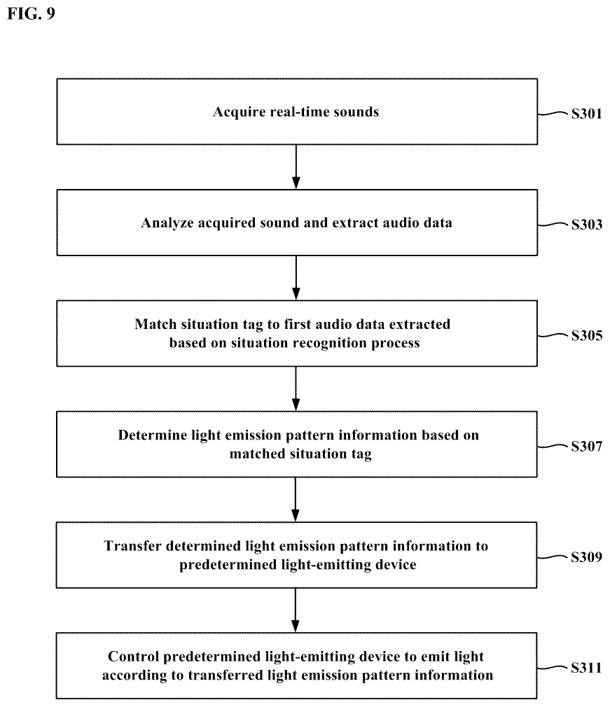

FIG. 9 is a flowchart illustrating a method for controlling a light emission pattern according to situation recognition according to an embodiment of the present disclosure.

Referring to FIG. 9, in an embodiment, the application 111 may acquire real-time sounds generated at a field (S301).

In addition, in an embodiment, the application 111 may analyze the acquired sound and extract audio data included in the relevant sound (S303).

In an embodiment, the application 111 may detect audio data by filtering keywords within the sound based on voice recognition and/or natural language processing (NLP).

In detail, in an embodiment, the application 111 may extract keywords within the sound based on voice recognition (ASR) utilizing an acoustic model trained on a phoneme and word basis and a language model trained on word-to-word relationships or grammatical rules, and/or NLP utilizing tokenization and syntactic analysis.

In an embodiment, such verbal data may be pre-stored in a database, labeled with the meaning of words or sentences included in the relevant sound, or with a title including the relevant meaning.

For example, when the first audio data includes the voice “The game is starting!”, the relevant audio data may be stored with the title information “Game start announcement” matched.

In other words, the audio data according to an embodiment may be classified into sound pattern data and/or verbal data, and the audio data may be a file matched with at least one of title information, BPM information, and/or light emission pattern information.

In other words, in an embodiment, the application 111 may extract the first audio data matching the features and keywords from the database.

In the above manner, in an embodiment, the application 111 may separate the first audio data included in the sound using the features and keywords sensed from the sound.

In addition, in an embodiment, the application 111 may match a situation tag to the first audio data extracted based on a situation recognition process (S305).

Herein, the situation tag according to an embodiment refers to information reflecting the field situation where the audio data is detected.

The types of situation parameters included in the situation tag may include a game type parameter, an emotion parameter, a team parameter, and/or an event parameter.

The game type parameter is information that determines the type of sports game (for example, baseball or soccer). The emotion parameter is information that determines a positive or negative emotional state (for example, cheering or booing). The team parameter is information that determines whether the situation concerns the team a light-emitting device holder cheers for or the opposing team. The event parameter is information that determines the occurrence of an event, such as a player substitution, a foul, a goal, or a lost point.

In an embodiment, the application 111 may perform a situation recognition process based on an artificial intelligence model to determine at least one parameter. In other words, at least one parameter may be determined based on a situation recognition algorithm.

In detail, in an embodiment, the application 111 may analyze the ambient sound of the first audio data based on an emotion analysis model.

The emotion analysis model may be a model that analyzes audio input in spectrogram form based on a CNN or RNN (LSTM/GRU) structure. For example, analysis may be performed based on pitch, volume, or duration.

The emotion analysis model may be pre-trained to take sound or audio data as input and output result data of positive or negative emotions.

In addition, in an embodiment, the application 111 may use the result data of the emotion analysis model to generate a situation tag that determines at least one light emission pattern component in advance.

More specifically, in an embodiment, the application 111 may use the result data of the emotion analysis model for the first audio data to generate a situation tag that determines manually set component values and/or randomly determined component values that satisfy a preset reference.

Upon description in further detail by way of example, when the first audio data includes positive emotions, a bright color such as “red” or “yellow” may be manually set for the light emission color, or a first color randomly determined from colors with a preset saturation or higher may be automatically set. In contrast, when the first audio data includes negative emotions, a dark color such as “Black” may be manually set for the light emission color. As such, the application 111 may generate a situation tag that determines light emission pattern components.

In addition, in an embodiment, the application 111 may analyze spatial information (DOA) of the first audio data based on a direction analysis model.

The direction analysis model may estimates the direction from which a sound is heard most loudly by applying a beamforming or source direction estimation (direction of arrival, DOA) algorithm. For example, the direction of sound generation may be estimated by linking with sound collection microphones distributed at a field.

The direction analysis model may be pre-trained to input sound or audio data and output result data that determines a home team or an opposing team.

In addition, in an embodiment, the application 111 may use the result data of the direction analysis model to generate a situation tag that determines at least one light emission pattern component in advance.

More specifically, in an embodiment, the application 111 may use the result data of the direction analysis model for the first audio data to generate a situation tag that determines manually set component values and/or randomly determined component values that satisfy a preset reference.

Upon description in further detail by way of example, when the first audio data is determined to have been collected from the direction of a home team, a situation tag that determines the light emission pattern components may be generated by, for example, setting the light emission color to a preset home team color.

In other words, in an embodiment, the application 111 may generate situation tags or determine emotion parameters and team parameters based on data output from the emotion analysis model and direction analysis model. In other words, the emotion parameters and team parameters may serve as indicators for understanding the flow of a game.

In addition, in an embodiment, the application 111 may analyze game information of the first audio data based on the game analysis model.

The game analysis model may applies the voice recognition (ASR) and NLP algorithms to estimate what type of event occurred in what type of game.

The game analysis model may be pre-trained to input sound or audio data and output result data that determines the type of game and event. For example, the game analysis model may sense the unique baseball batting sound, the unique soccer whistle sound, the unique basketball buzzer sound, or words such as “home run,” “offside,” and “three-point shot” included in the input sound and output result data.

In this connection, each piece of game information (in other words, event) may be pre-matched with light emission pattern information, in which at least one light emission pattern component is determined.

In other words, based on data output from the aforementioned artificial intelligence models, in an embodiment, the application 111 may determine a game type parameter, an emotion parameter, a team parameter, and/or an event parameter.

Accordingly, in an embodiment, the application 111 may match a situation tag, in which at least one parameter is determined, to the first audio data.

The matched situation tag may be in the form of result data inserted for each parameter, or may be a combination of two or more parameters, such as “home team scoring situation during a baseball game” or “opposing team foul situation.”

In addition, in an embodiment, the application 111 may determine light emission pattern information based on the matched situation tag (S307).

A detailed description of the determined light emission pattern information will be omitted by applying the description described in relation to FIG. 6, and only features not described in the relevant portion will be described.

In an embodiment, the application 111 may determine light emission pattern information by directly determining at least one light emission pattern component among light emission mode, light emission color, light emission time, light emission brightness, light emission effect, and light emission speed to correspond to the matched situation tag, or by determining production data.

In this connection, in an embodiment, the application 111 may determine the light emission pattern information 520 based on the mapping table (MT) and/or rule set that corresponds each situation tag and a light emission pattern component.

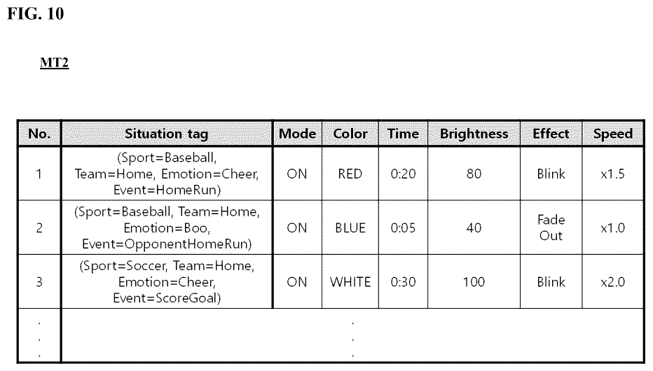

FIG. 10 is an example of a second mapping table corresponding to a situation tag and a light emission pattern component according to an embodiment of the present disclosure.

Referring to FIG. 10, in an embodiment, the application 111 may determine light emission pattern information based on a second mapping table MT2 that corresponds at least one light emission pattern element to a situation tag.

The first mapping table MT1 and the second mapping table MT2 may be concepts that are differentiated according to which target the light emission pattern component corresponds to.

The situation tag may display the game type parameter, the emotion parameter, the team parameter, and/or the event parameter.

A plurality of situation tags may be formed depending on the number of cases. When similar situation tags are created between parameters, the light emission pattern component values mapped to the existing situation tags may be reflected and generated.

In the illustrated example, both the situation tag and the light emission pattern component are displayed. However, in other embodiments, when necessary, the application 111 may simplify the light emission pattern component into a production data serial number or deliver only the changed values of specific parameters to change as separate parameters.

For example, when a first situation tag is sensed and the relevant serial number is searched to drive the light emission pattern, the application 111 may apply an additional parameter that changes the light emission speed parameter from ×1.5 to ×2.0.

In an embodiment, the application 111 may determine light emission pattern information using an intuitive, rule-based approach based on the second mapping table MT2.

In another embodiment, the application 111 may determine light emission pattern information by training a predetermined artificial intelligence model that automatically recommends the most appropriate light emission pattern using the second mapping table (MT2), and then acquiring light emission pattern information output from the trained artificial intelligence model.

In other words, in another embodiment, the application 111 may determine light emission pattern information using a machine learning-based method that automatically recommends light emission pattern information corresponding to a situation tag using a pre-trained artificial intelligence model.

The aforementioned light emission pattern determination process applies both to sound pattern data and verbal data included in audio data. When the audio data is sound pattern data, in an embodiment, the application 111 may determine the light emission speed parameter based on the light emission control assembly 180.

Specifically, in an embodiment, the application 111 may directly measure and extract BPM information of the relevant sound pattern data based on the BPM tracker of the light emission control assembly 180 or extract BPM information pre-matched to each sound pattern data to determine the light emission speed parameter.

In this connection, the one piece of audio data may include the plurality of pieces of BPM information. In addition, each of the plurality of sound pattern data included in the one piece of audio data may include one piece of BPM information.

In addition, in an embodiment, the application 111 may extract only the BPM information corresponding to the currently playing section and vary the light emission speed based thereon. In other words, the light emission speed of the next section to be played may be predicted based on the currently playing section and the light emission speed may be automatically transitioned to the predicted value.

In other words, in an embodiment, the application 111 may determine the light emission pattern information based on a situation tag matched to audio data including sound pattern data and verbal data.

In addition, in an embodiment, the application 111 may transfer the determined light emission pattern information to a predetermined light-emitting device (S309).

In addition, in an embodiment, the application 111 may control the predetermined light-emitting device to emit light according to the transferred light emission pattern information (S311).

The light-emitting device 300 according to various embodiments may emit light according to the transferred light emission pattern information by reading and activating the first production data matching the production data included in the control command from the storage unit.

In an embodiment, the application 111 controls the light-emitting devices 300 according to the first light emission pattern information determined by the first audio data. When another piece of second audio data is sensed in real-time sound including the first audio data, the application 111 may newly generate a control signal including the second light emission pattern information that changes the light emission pattern components included in the existing first light emission pattern information.

This may be designed to produce a more dramatic light emission effect by utilizing the existing light emission pattern information when the timing of occurrence of a game event (for example, home run, score) overlaps during control with the light emission pattern information based on the sound pattern data.

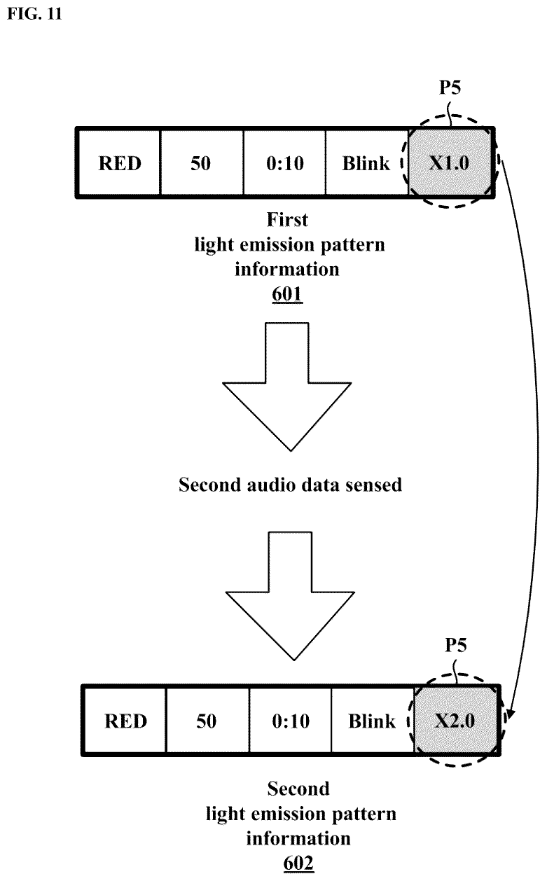

FIG. 11 is a schematic diagram illustrating an example of a method for generating second light emission pattern information according to an embodiment of the present disclosure.

In an embodiment, when the second audio data containing a new situation tag is sensed, the application 111 may change at least one light emission pattern component included in first light emission pattern information 601 based on the first audio data to generate second light emission pattern information 602.

In this connection, in an embodiment, the application 111 may determine the light emission pattern component to be changed based on the parameters of the new situation tag matched to the second audio data, and determine what value to set the determined light emission pattern component to.

To this end, the light emission pattern component to be changed and its value may be preset for each parameter of the acquired second audio data.

Referring to the example illustrated in FIG. 11, the second audio data may match a situation tag including a positive event parameter. The preset light emission pattern component to be changed may be “light emission speed,” and the value to be changed may be “double.” Accordingly, the application 111 may double the fifth light emission pattern component P5, which is the light emission speed of the first light emission pattern information 601.

Accordingly, in an embodiment, the application 111 may control the light emission of the light-emitting device 300 by regenerating a control signal including the changed light emission pattern information and retransferring the same to the light-emitting device 300.

In addition, in an embodiment, when the application 111 determines the light emission pattern information for the first audio data 400 and/or the first sound pattern data 410, the light-emitting device 300 may be controlled to repeatedly loop the first light emission pattern information and/or the first production data according to the light emission speed parameter.

In addition, in an embodiment, when a predetermined specific rhythm is sensed, the application 111 may generate section production information, not BPM information, and change the light emission pattern according to the generated section production information. The above description applies to the content of the section production information.

In addition, in an embodiment, the application 111 may update the team name, player name, and sports (for example, sport type and/or game information) included in the situation tag of the BPM information.

For example, the application 111 may update the database and/or the storage unit 340 of the light-emitting device 300 by adding and/or deleting tags such as new recruits, retired players, and new games (for example, Korean national team tryouts, Liverpool vs. Atletico Madrid matches).

The embodiments of the present disclosure described above may be implemented in the form of program commands which may be executed through various types of computer constituting elements and recorded in a computer-readable recording medium. The computer-readable recording medium may include program commands, data files, and data structures separately or in combination thereof. The program commands recorded in the computer-readable recording medium may be those designed and configured specifically for the present disclosure or may be those commonly available for those skilled in the field of computer software. Examples of a computer-readable recoding medium may include magnetic media such as hard-disks, floppy disks, and magnetic tapes; optical media such as CD-ROMs and DVDs; and hardware devices specially designed to store and execute program commands such as ROM, RAM, and flash memory. Examples of program commands include not only machine codes such as those generated by a compiler but also high-level language codes which may be executed by a computer through an interpreter and the like. The hardware device may be replaced with by one or more software modules to perform the operations of the present disclosure, and vice versa.

Specific executions described in the present disclosure are exemplary embodiments and the scope of various embodiments of the present disclosure is not limited even by any method. For brevity of the specification, descriptions of conventional electronic configurations, control systems, software, and other functional aspects of the systems may be omitted. Further, connection or connection members of lines among components exemplarily represent functions connections and/or physical or circuitry connections and may be represented as various functional connections, physical connections, or circuitry connections which are replaceable or added in an actual device. Further, unless otherwise specified, such as “essential” or “important,” the connections may not be components particularly required for application of various embodiments of the present disclosure.

Further, in the detailed description of the present disclosure, which is described, while the present disclosure has been described with respect to the preferred embodiments, it will be understood by those skilled in the art or those skilled in the art having ordinary knowledge in the technical field that various changes and modifications of various embodiments of the present disclosure may be made without departing from the spirit and the technical scope of the present disclosure described in the following claims. Accordingly, the technical scope of various embodiments of the present disclosure should not be limited to the contents described in the detailed description of the present disclosure but should be defined by the claims.

What is claimed is:

1. A method for controlling light emission based on an audio response by an application of a central control terminal, the method comprising:
acquiring sound through at least one sound collection microphone;
extracting audio data from the acquired sound;
acquiring first sound pattern data, which is a section having a predetermined sound pattern, from the audio data;
generating light emission information that specifies a light emission form of a light-emitting device by adjusting a light emission speed or a light emission pattern according to metadata matched to the first sound pattern data; and
transmitting the generated light emission information to a predetermined light-emitting device.

2. The method of claim 1, wherein generating the light emission information comprises at least one of:
determining light emission pattern information by setting respective values of a plurality of light emission pattern components; or
determining pre-stored production data in which the values of the plurality of light emission pattern components have been determined in advance.

3. The method of claim 1, wherein transmitting the generated light emission information to the predetermined light-emitting device comprises including, in a control signal to be transmitted, a control command for causing the light-emitting device to emit light based on at least one of the light emission pattern information or the production data, with light emission speed information included in the light emission information.

4. The method of claim 1, wherein extracting the audio data comprises:
amplifying the acquired sound based on a light emission control system;
removing noise from the amplified sound based on a noise removal algorithm;
extracting features or keywords from the noise-removed sound based on a deep learning model pre-trained with an audio dataset; and
extracting first sound pattern data corresponding to the features or keywords of the extracted sound from audio data pre-stored in a database.

5. The method of claim 1, wherein acquiring the first sound pattern data comprises at least one of:
reading BPM information from the first sound pattern data in a metadata format in which at least one of the BPM information, which is feature information that determines a speed of the first sound pattern data, light emission pattern information that determines a light emission attribute of the light-emitting device, or light emission speed information that determines a light emission speed of the light-emitting device, is tagged in advance; or
measuring the BPM information of the first sound pattern data included in the audio data based on a light emission control system.

6. The method of claim 5, wherein measuring the BPM information of the first sound pattern data based on the light emission control system comprises:
determining, when a change in a first BPM value to a second BPM value is sensed, a section in which the first BPM value is maintained as the first sound pattern data; and
determining the first BPM value as the BPM information in the determined first sound pattern data.

7. The method of claim 6, wherein generating of the light emission information comprises generating the light emission information by determining at least one of: section information determining which section of the extracted audio data the first sound pattern data corresponds to; the light emission pattern information determining at least one light emission pattern component value among a light emission mode, light emission color, light emission time, light emission brightness, and light emission effect; or the light emission speed information determining the light emission speed based on BPM information of the section information.

8. The method of claim 7, wherein generating the light emission information by determining the light emission pattern information comprises one of:
determining the light emission pattern component value based on a mapping table that corresponds the light emission pattern information and production data by BPM range; or
automatically acquiring and determining recommended light emission pattern information on the BPM information using a light emission pattern generation algorithm.

9. The method of claim 8, wherein determining the light emission pattern component value based on the mapping table further comprises determining a serial number of the production data in which a plurality of light emission pattern component values are determined in advance and a first light emission pattern component change value to be changed in the production data.

10. The method of claim 1, further comprising:
sensing a specific rhythm section from first sound pattern data included in the audio data; and
generating section production information that sets light emission pattern information matching the first sound pattern data to be played at a light emission timing corresponding to a timestamp recorded in the sensed specific rhythm section.

11. The method of claim 10, further comprising transferring, to the light-emitting device, a control command to give priority to the generated section production information over metadata of the first sound pattern data when the section production information is generated.

12. The method of claim 1, wherein transmitting the generated light emission information to the predetermined light-emitting device comprises generating a control command that activates first production data included in the generated light emission information among production data pre-stored in a plurality of the light-emitting devices.

13. The method of claim 1, wherein extracting the audio data further comprises:
classifying the audio data into sound pattern data and verbal data; and
matching a situation tag comprising at least one situation parameter to the extracted audio data using a situation recognition algorithm.

14. The method of claim 13, wherein matching the situation tag comprises:
determining the at least one situation parameter based on at least one artificial intelligence model among an emotion analysis model that analyzes ambient sounds of the audio data to determine emotion parameters, a direction analysis model that analyzes a direction of occurrence of the audio data to determine team parameters, and a game analysis model that performs voice recognition and natural language processing to determine event parameters; and
matching a situation tag comprising the determined at least one situation parameter to the audio data.

15. The method of claim 13, wherein determining the light emission pattern information further comprises:
additionally detecting second audio data from sounds comprising the audio data;
recognizing a new situation tag from the second audio data; and
generating second light emission pattern information by changing at least one light emission pattern component among the light emission pattern information corresponding to the audio data according to the recognized new situation tag.

16. A system for controlling light emission based on an audio response, the system being interlocked with at least one light-emitting device, and comprising:
at least one memory; and
at least one processor assembly,
wherein at least one application stored in the memory and executed by the processor assembly to perform a method for controlling the light emission based on the audio response operates in accordance with instructions for:
acquiring sound through at least one sound collection microphone;
extracting audio data from the acquired sound;
acquiring first sound pattern data, which is a section having a predetermined sound pattern, from the audio data;
generating light emission information that specifies a light emission form of the light-emitting device by adjusting a light emission speed or a light emission pattern according to metadata matched to the first sound pattern data; and
transmitting the generated light emission information to a predetermined light-emitting device.

17. A light-emitting device comprising:
a short-range transceiver configured to receive a control signal comprising a control command to cause a light-emitting unit to emit light according to predetermined emission information;
the light-emitting unit configured to perform light emission based on the received light emission information; and
a processor configured to control the light emission,
wherein the processor is configured to:
acquire sound through at least one sound collection microphone;
extract audio data from the acquired sound;
acquire first sound pattern data, which is a section having a predetermined sound pattern, from the audio data;
determine at least one of light emission pattern information or production data that matches the acquired first sound pattern data; and
adjust at least one of a light emission speed or a light emission pattern for at least one of the determined light emission pattern information or production data.
